(19) United States
(12) Patent Application Publication
(10) Pub. No.: US 2016/0214081 A1
(43) Pub. Date: Jul. 28, 2016

(54) Extruded Granular Oil Sorbent

(71) Applicant: Pioneer Pet Products, LLC, Cedarburg, WI (US)

(72) Inventor: John M. Lipscomb, Cedarburg, WI (US)

(21) Appl. No.: 15/007,204

(22) Filed: Jan. 26, 2016

Related U.S. Application Data
(60) Provisional application No. 62/107,744, filed on Jan. 26, 2015.

(51) Int. Cl. B01J 20/24; B01J 20/28

(52) U.S. Cl. CPC B01J 20/24; B01J 20/2803; B01J 20/28011

(57) ABSTRACT

Granular sorbent well suited for adsorbing non-aqueous liquid, preferably oil, with a preferred granular sorbent formed of sorbent granules which preferably are organic and formed of or by organic sorbent starch-containing pellets extruded from a starch-containing admixture. A preferred extruded sorbent pellet preferably is formed with a porous outer surface and a void filled inner starch matrix enhancing adsorption. Extruded sorbent pellets can be treated with sorbent enhancing material and/or coated with another adsorbent, such as smectite, bentonite, producing sorbent granules usable the granular sorbent. In use, liquid soluble material formed in each pellet during extrusion can help adhere together sorbent granules and/or pellets producing a mass or even a clump that is easy to pick up and dispose. In a preferred method, an activating liquid, preferably an aqueous liquid, is applied onto spent granules or pellets to bind them together into such a mass or clump.

### CROSS REFERENCE

This application claims priority in U.S. Provisional Patent Application No. 62/107,744, filed Jan. 26, 2015, under 35 U.S.C. §119(e), the entirety of which is hereby expressly incorporated herein by reference.

### FIELD

The present invention is directed to extruded granular sorbent, a method of making extruded granular sorbent, and more particularly to extruded granular oil sorbent and method of making same.

### BACKGROUND

Sorbents are insoluble materials or mixtures of materials used to recover liquids through the mechanism of absorption, or adsorption, or both. Absorbents are materials that pick up and retain liquid by absorbing or soaking up the liquid. Adsorbents are insoluble materials that are coated by a liquid on its surface. To be useful in combating oil spills, sorbents need to be oleophilic (oil-attracting) and hydrophobic (water-repellent).

Sorbents are used widely to pick up many different types of liquids including water, oil, chemicals in liquid form, and other types of liquid containing some water in it. Although sorbents are commonly used as the sole cleanup method in many small spills, they are also frequently used to remove liquid left over after other cleanup methods, such as skimmers, have been used. In hard-to-reach places where other types of cleanup methods cannot be used, sorbents may be the only thing available that can be used. Depending upon the liquid absorbed, e.g., oil, sorbent materials and any liquid that is removed from sorbent materials must be disposed of in accordance with approved local, state, and federal regulations.

Sorbents can be divided into three basic categories: (a) natural organic sorbents, (b) natural inorganic sorbents, and (c) synthetic sorbents. The choice of which type of sorbent to use is often dependent upon the type of liquid that needs to be cleaned up as well as the characteristics of the area sought to be remediated.

Commonly used organic sorbents include peat moss, straw, hay, sawdust, ground corn cobs, feathers, as well as other readily available carbon-based products. While organic sorbents are in use, including organic sorbents intended for use to adsorb oil, they are often viewed as being less desirable than natural inorganic sorbents and synthetic sorbents. Many organic sorbents are formed of loose particles making them difficult to collect after being spread on water. Some organic sorbents tend to adsorb water along with oil causing the sorbents to sink if spread on water. While in the past, flotation devices have been used to try and remedy these disadvantages. For example, empty drums have been attached to sorbent bales of hay to prevent hay from sinking and mesh can be used to hold together loose sorbent particles making it much easier to pick them up when finished.

Commonly used inorganic sorbents include clay, perlite, vermiculite, glass wool, sand and volcanic gas. Inorganic sorbents are more commonly used in oil adsorbing applications though they are not without significant limitations. While natural inorganic sorbents are readily available in large quantities and typically are relatively inexpensive, these types of sorbents are virtually unusable on the surface of water.

Synthetic sorbents include man-made materials that are similar to plastics, such as polyurethane, polyethylene, and polypropylene. These type of synthetic sorbents are designed to adsorb liquids onto their surfaces. Other synthetic sorbents include cross-linked polymers and rubber materials, which adsorb liquids into their solid structure, causing the sorbent material to swell. There are synthetic sorbents currently in use which can adsorb multiple times their own weight in oil. Where used to adsorb or otherwise pickup water, some synthetic sorbents can hold even more

The characteristics of the type of liquid to be picked up as well as the characteristics of the sorbent to be used must be taken into consideration when choosing sorbents to clean up a spill of a particular liquid. For example, a type of sorbent well suited for use in cleaning up water or a chemical liquid containing water may not be well suited for picking up oil, e.g., petroleum-based oil. Similarly, a type of absorbent well suited for use in cleaning up liquids made up of heavy hydrocarbons, such as petroleum-based oil, may not be as well suited for use in picking up light hydrocarbons, such as gasoline, diesel fuel, and benzene. Characteristics including: (a) rate of absorption, (b) rate of adsorption, (c) retention, (d) ease of wetting the sorbent and, (e) ease of sorbent application are just a few of the characteristics typically taken into consideration when choosing sorbents for a particular cleanup job.

Rate of absorption almost always needs to be taken into consideration as the rate of absorption of heavier molecular weight liquids is slower than the rate of lighter molecular weight liquids. For example, the absorption of oil is faster for lighter oil products. The same is true with regard to light hydrocarbons. Once the liquid is absorbed, it also obviously is very important that the absorbed liquid not be easily released.

The same is true with regard to rate of adsorption as thicker or heavier molecular weight liquids tend to adhere to the sorbent more effectively and efficiently if they can be wetted to the sorbent. For example, thicker oils adhere to the surfaces of the absorbent more effectively than thinner or lighter oils.

Retention also is a very important characteristic that needs to be taken into consideration. The weight of liquid recovered by a sorbent can cause breakdown of the sorbent structure such as by causing sagging and deformation of the sorbent structure. When liquid-holding sorbent is picked up, typically by being lifted up or scooped up, some of the trapped liquid can undesirably be released from the sorbent obviously reducing retention. For example, the weight of recovered oil can cause a sorbent structure to sag and deform such that some of the oil trapped inside the sorbent can be released when being lifted out of the water. Lighter, less viscous liquids, e.g. light hydrocarbons, is lost more easily than heavier, more viscous liquids, e.g. heavier, more viscous oils, during recovery of sorbent material.

If a sorbent does not possess great enough retention for the type of liquid to be picked up using the sorbent, release of too much trapped liquid during sorbent recovery can undesirably lead to secondary contamination. While it obviously is undesirable where secondary contamination occurs during recovery, there also can be instances where the occurrence of secondary contamination after recovery can be just as bad or even worse. Therefore, it is desirable to choose a sorbent with a desirably high retention that readily retains liquid long after being recovered.

Ease of application also is very important to evaluate when choosing sorbents. Sorbents may be applied to spills manually or using equipment such as dispensers, blowers or fans. Many natural organic sorbents are in loose material form which can be very difficult to apply during windy conditions. Natural inorganic sorbents, such as clay and vermiculite, are dusty, can also be difficult to apply, and can be potentially hazardous if inhaled.

Conventional oil absorbents made for picking up oil on the ground, on the floor of a garage, or other on-land use are typically natural inorganic sorbents formed of inorganic porous pebbles or rocks made of a natural inorganic sorbent like calcium bentonite or even bentonite. They do not absorb virtually any oil or other water insoluble/immiscible liquids when used as an oil absorbent as their mechanism of action is primarily adsorption as they pick up oil and other water insoluble/immiscible liquid by the inorganic oil absorbent material becoming coated with the oil and other water insoluble/immiscible liquid. As a result, their capacity to pick up and retain oil and other water insoluble/immiscible liquids is poor per gram of weight of conventional absorbent.

In addition, conventional oil absorbents are heavy to transport and difficult to dispose. Recovery of any portion of the oil picked up by the sorbent is virtually impossible and the cost of disposing inorganic sorbent after use tends to be expensive. Many times, used inorganic sorbent cannot be disposed like conventional refuse in a conventional landfill as it can in certain circumstances require the same type of treatment and disposal to be done as for chemical and hazardous material waste. Expensive high temperature treatment in a kiln is typically required, which even then does not completely dispose of everything. While ash, pebbles and rocks leftover can be used in small percentages in concrete, it still needs to be handled and transported adding to overall disposal costs.

What is needed is a granular sorbent that overcomes one or more of the above drawbacks. What also is needed is a granular sorbent formed of organic sorbent granules possessing improved sorbent properties.

### SUMMARY

The present invention is directed to granular sorbent that preferably is an extruded granular sorbent formed of sorbent granules each formed of or from pellets extruded from a starch mixture producing sorbent granules composed of organic extruded sorbent pellets well suited for oil sorbent use, gasoline sorbent use, diesel sorbent use, and and/or sorbent use in picking up one or more other liquids including petroleum-based distillates, solvents, oils, and the like. A preferred granular sorbent is an extruded granular oil sorbent formed of oil sorbent granules each formed of or from extruded oil sorbent pellets.

Each extruded oil sorbent pellet preferably is extruded from a starch admixture under extruder operating parameters and conditions that produces extruded oil sorbent pellets composed of liquid soluble material, having a porous outer surface, and possessing a void filled pellet interior advantageously facilitating oil adsorption during sorbent use. In a preferred method and embodiment, each extruded oil sorbent pellet preferably also includes liquid soluble binder that helps agglutinate oil sorbent pellets wetted with oil during adsorption of oil during sorbent use facilitating their pick up after sorbent use.

In another preferred method and embodiment, each extruded oil sorbent pellet preferably is extruded from a starch admixture under extruder operating parameters and conditions that produces extruded oil sorbent pellets composed of water soluble material, having a porous outer surface, and possessing a void filled pellet interior advantageously facilitating oil adsorption during sorbent use. In one such preferred method and embodiment, each extruded oil sorbent pellet preferably also includes water soluble binder that helps agglutinate oil sorbent pellets wetted with oil during or after adsorption of oil when the oil holding pellets are wetted with an aqueous liquid. In such a preferred method and embodiment, application of aqueous liquid onto oil holding pellets that have absorbed oil preferably at least partially dissolves or solubilizes water soluble binder in one or more of the aqueous wetted pellets forming a clump of the pellets that solidifies and hardens into a solid clump when the water in the clump evaporates or dries.

One or more of the extruded oil sorbent pellets of a preferred granular oil sorbent of the present invention is extruded under extruder operating parameters and conditions that forms a splayed pellet having at least one elongate lobe extending outwardly from a larger pellet body that also preferably exteriorly exposes at least a portion of a starch matrix pellet interior that preferably is void filled thereby advantageously increasing oil adsorption surface area increasing oil adsorption capacity. One or more of such splayed extruded oil sorbent pellets can also have one or more tendrils extending outwardly from either the pellet body or a lobe of the pellet with each carrying smaller than both the pellet body and each lobe.

### DRAWING DESCRIPTION

One or more preferred exemplary embodiments of the invention are illustrated in the accompanying drawings in which like reference numerals represent like parts throughout and in which:

FIG. 1 is a top plan view of a preferred but exemplary embodiment of a granular sorbent formed of a plurality of extruded organic sorbent pellets of the present invention;

FIG. 2 is a top plan view of a preferred but exemplary embodiment of a preferred splayed adsorption surface area increased extruded organic sorbent pellet of the present invention;

FIG. 3 is a top plan view of an agglutinated mass formed of the extruded organic sorbent pellets; of FIG. 1 when adsorbing an oil in an oil remediation area in which the pellets have been applied;

FIG. 4 is a top plan view of the agglutinated mass formed in FIG. 3 after activation of the pellets with an aqueous liquid, preferably water, which at least partially dissolves or solubilizes pellet boundaries coalescing the pellets into a single amorphous clump adhered together by flowable adhesive from liquid soluble binder which more readily can be picked up and disposed of.

Before explaining one or more embodiments of the invention in detail, it is to be understood that the invention is not limited in its application to the details of construction and the arrangement of the components set forth in the following description and illustrated in the drawings. The invention is capable of other embodiments or being practiced or carried out in various ways. Also, it is to be understood that the phraseology and terminology employed herein is for the purpose of description and therefore should not be regarded as limiting.

### DETAILED DESCRIPTION

The present invention is directed to granular oil sorbent composed of granules extruded from a starch-containing material, preferably a starch-containing organic material, more preferably a starch-containing cereal grain, that is well suited for absorbing oil, including mineral oil, and other types of liquids, including non-aqueous liquids. The present invention also is directed to granular oil sorbent having oil sorbent granules formed of organic oil sorbent pellets extruded from such a starch-containing material.

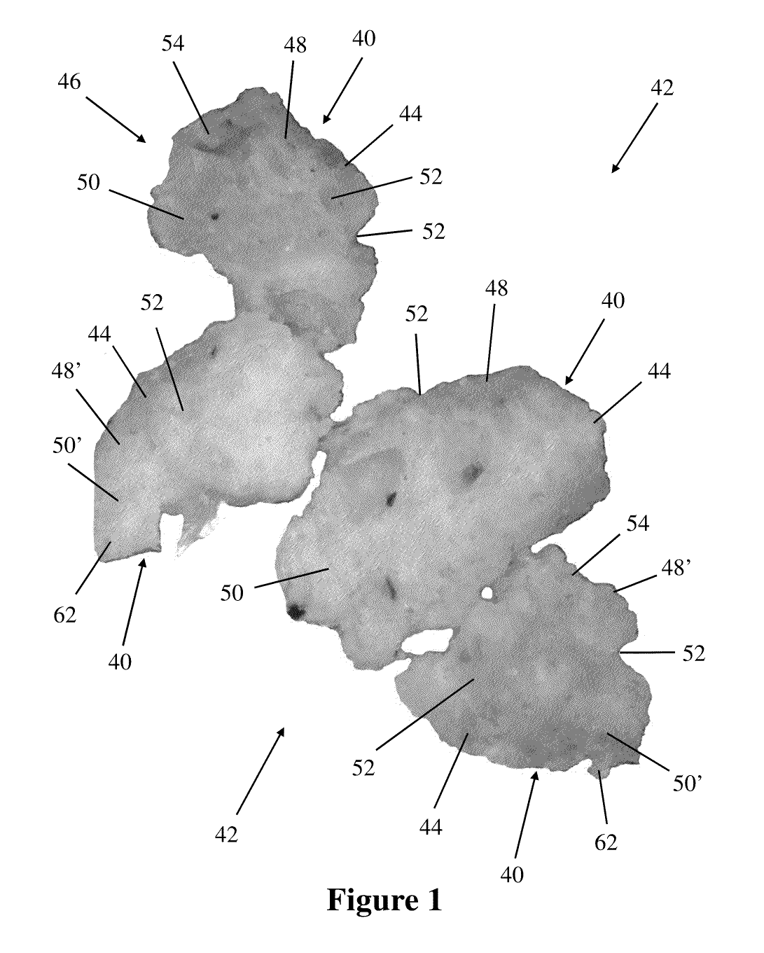

FIG. 1 illustrates a plurality of pairs of extruded sorbent granules 40 of a granular sorbent 42 where each one of the extruded sorbent granules 40 is an extruded oil sorbent granule 44 of the present invention forming granular sorbent that is an extruded granular oil sorbent 46 in accordance with the present invention. Each one of the extruded oil sorbent granules 44 preferably is formed of or from a pellet 48 extruded from a starch-containing material under extruder operating parameters and conditions that produce extruded oil sorbent granules 44 in accordance with the present invention which are not only oil sorbent but which preferably are also water sorbent. As discussed in more detail below, extruded oil sorbent granules 44 of the present invention are formed of or from pellets 48 extruded from a starch-containing mixture under extruder operating parameters and conditions that produce such extruded oil sorbent granules 44 that are oil sorbent, but such extruded oil sorbent granules 44 are also sorbent of other types of liquids, including non-aqueous liquids, like gasoline, kerosene, and other non-aqueous liquids containing a mixture of hydrocarbons and/or petroleum distillates. Where such oil sorbent granules 44 are formed of extruded pellets 48 in their as-extruded form, each one of such oil sorbent granules 44 is an organic oil sorbent granule 44.

A granular oil sorbent 46 in accordance with the present invention is composed of a majority, e.g., at least 50%, and preferably is composed substantially completely, e.g., at least 75%, of extruded oil sorbent granules 44 each formed of or from organic oil sorbent pellets 48 that can all be of substantially the same size, but which preferably are of at least a plurality of different sizes. Although not shown, a granular oil sorbent 46 of the present invention can also include a plurality of other types of oil sorbent supporting granules and/or particles each of which are not extruded and each of which are composed of a material different than the oil sorbent pellets 48 and/or granules 44.

A preferred oil sorbent granule 40 is formed of or from a pellet 48 extruded from a starch-containing mixture such that each extruded pellet 48 is an organic oil sorbent pellet 48 composed of at least 40% starch by pellet weight, preferably composed of at least 50% starch by pellet weight, and more preferably composed of at least 60% starch by pellet weight. As discussed in more detail below, a single screw or twin screw extruder extrudes such a starch-containing mixture under extruder operating parameters and conditions in accordance with a method of making oil sorbent pellets of the present invention forming starch-containing pellets 48 that are not only water sorbent but advantageously also highly oil sorbent. As also discussed in more detail below, oil sorbent pellets 48 extruded from such a starch containing mixture by a single screw or twin screw extruder operating under such conditions advantageously have an oil sorbent capacity of at least 0.85 grams of oil per gram of the pellets 48 and preferably have an oil sorbent capacity of at least 0.90 grams of oil per gram of pellets 48.

Each one of the extruded oil sorbent pellets 48 of granular oil sorbent 46 of the present invention has an outer surface 50 that can and preferably does have at least one pore 52 formed therein that facilitates oil pickup by the pellet 48 during use by enabling oil to enter through the pore 52 and penetrate inside the pellet 48. In a preferred extruded granular oil sorbent 46, at least a plurality, preferably at least a plurality of pairs, i.e. at least three, of the pellets 48 each having an outer surface 50 that is a porous outer surface 54 having at least a plurality of the oil-adsorption enhancing pores 52 formed therein.

In addition, each one of the extruded oil sorbent pellets 48 is extruded from such a starch-containing mixture at or under extruder operating parameters and conditions that form one or more oil adsorption enhancing pockets or voids within a starch matrix interior of the pellet 48. In a preferred granular oil sorbent embodiment, extruded granular oil sorbent 46 has at least a plurality, preferably at least a plurality of pairs, i.e. at least three, of extruded oil sorbent pellets 48 each having a void-filled interior, preferably a void-filled starch matrix interior, formed of at least a plurality of internal voids or pockets within the pellet 48 each of which can and preferably is air-filled prior to oil adsorption use. In one such preferred method of extruding oil sorbent pellets 48, the starch-containing mixture is extruded at or under extruder operating parameters and conditions which cause or produce pellet expansion during pellet extrusion in a manner that causes one or more such pockets or voids to form within extruded oil sorbent pellets 48.

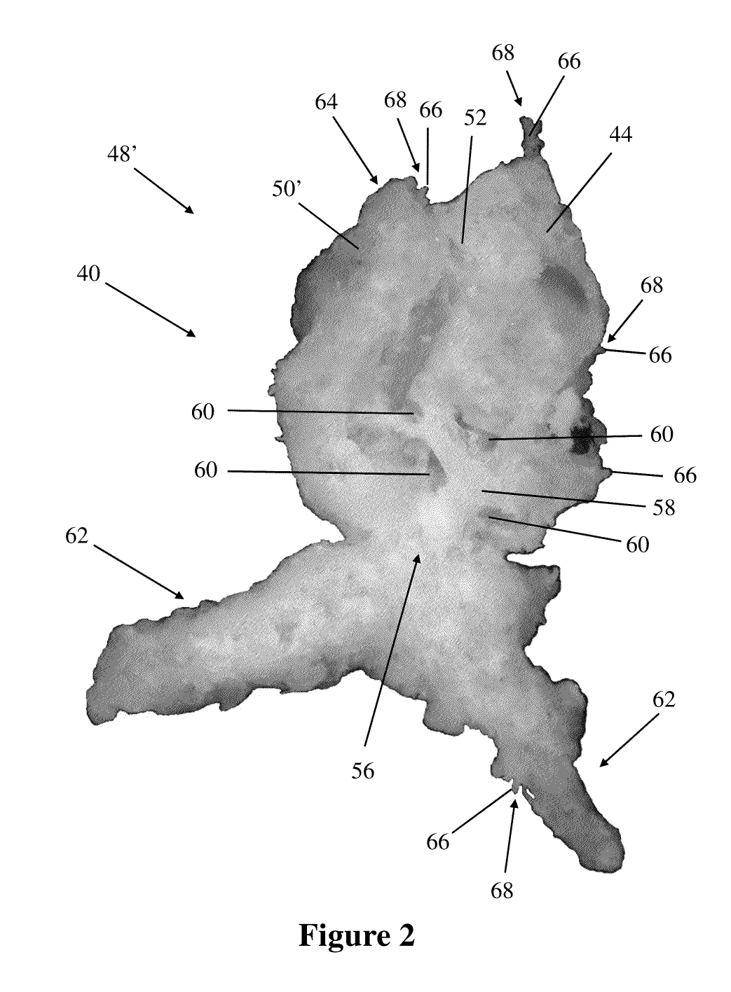

With additional reference to FIG. 2, extruded granular oil sorbent 46 of the present invention can include a plurality, even a plurality of pairs, i.e., at least three, of increased adsorption surface area oil sorbent pellets 48′ like that shown in FIG. 2, a plurality of which are also depicted in FIG. 1. Each one of the increased adsorption surface area oil sorbent pellets 48′ are very similar, if not substantially identical, in composition to pellets 48 but which are each extruded under extruder operating parameters and conditions that causes each pellet 48′ to become splayed in a manner that increases the amount of exposed or exterior pellet surface area 50′ available for oil to adhere to during adsorption use.

Caused by or during extrusion, each splayed oil sorbent pellet 48′ is extruded in a manner that exposes at least some of a starch matrix pellet interior 56, as depicted in FIG. 2, which preferably is a void-filled pellet interior 58 having at least one and preferably at least a plurality of spaced apart pockets or voids 60 formed therein by or during splayed pellet extrusion. Not only does splaying of each such pellet 48′ by or during extrusion produce such an enhanced oil adsorption pellet 48′ in accordance with the present invention that possesses greater surface area than pellet 48, but exposing at least a portion of the interior 58 of each pellet 48′ during splayed pellet extrusion further enhances adsorption by providing more surface area for oil being picked up to adhere to and by providing more voids and pockets in which oil being picked up is drawn into. It should be noted that such a void filled and/or starch matrix pellet interior also is formed by or during extrusion of each non-splayed oil absorbent pellet 48 but does not become exteriorly exposed such that it remains within the interior of the pellet 48.

In addition, each splayed increased adsorption surface area sorbent pellet 48′ can and preferably also does have one or more smaller elongate lobes 62 as also shown in FIG. 2 which each project outwardly from a larger central body 64 of the pellet 48′ with each lobe 62 being narrower in width than pellet body 64. Where the splaying extrusion process produces splayed pellets 48′ with one or more such lobes 62, the presence of the one or more lobes 62 not only increases pellet adsorption surface area thereby enabling more oil to be picked up during oil sorbent use but also advantageously facilitates engagement with one or more extruded sorbent granules 40, preferably one or more extruded oil absorbent granules 44, each of which can be and/or formed of or from an extruded oil sorbent pellet 48 and/or 48′. By increasing extruded oil sorbent pellet surface area available for sorption, not only is oil adsorption enhanced but the amount of oil picked up by such a lobe equipped splayed oil sorbent pellet 48′ is increased thereby advantageously increasing the oil adsorption capacity of such splayed pellets 48′. By such lobes 62 on one or more pellets 48′ also facilitating engagement, e.g. interlocking engagement, with other granules, particles and/or pellets of granular oil sorbent of the present invention during sorbent use, agglutination of granules, particles and/or pellets of the granule sorbent can and preferably does occur advantageously facilitating cleanup after sorbent use.

With continued reference to FIG. 2, each splayed oil sorbent pellet 48′ can also be fibrillated during the splaying extrusion process having one or more elongate fibrils 66 which are smaller than lobes 62 which extend outwardly from either the pellet body 64 or one of the lobes 62, where splayed pellet 48′ has a lobe 62. Where such a splayed pellet 48′ has one or more such fibrils 66, each one of the fibrils 66 preferably is at least 10 microns or μm in length and preferably is no larger than 1000 microns or μm in length. The presence of such fibrils 66 not only increase sorption surface area but also function as liquid wicks 68 that speed sorption by causing oil and other liquids, including water, to be more rapidly picked up by fibril-equipped pellet 48′ via capillary or wicking action. By increasing extruded oil sorbent pellet surface area available for sorption, not only is oil adsorption enhanced but the amount of oil picked up by such fibril-equipped splayed oil sorbent pellets 48′ is increased thereby advantageously increasing the oil adsorption capacity of such splayed pellets 48′. The presence of fibrils 66 on pellets 48′ equipped therewith advantageously also facilitates engagement, e.g. interlocking engagement, with other granules, particles and/or pellets of granular oil sorbent of the present invention during sorbent use, such that agglutination of granules, particles and/or pellets of the granule sorbent can and preferably does occur advantageously facilitating cleanup after sorbent use.

Each extruded oil sorbent pellet 48 and/or 48′ preferably is extruded from a starch-containing mixture, e.g., admixture, containing at least 40% starch by dry admixture weight, e.g. before any water is added, preferably containing at least 50% starch by dry admixture weight, and more preferably containing at least 60% starch by dry admixture weight. Such a starch-containing admixture preferably has a moisture content no greater than 30%, preferably no greater than 28% and more preferably no greater than 25%. In one preferred method of making oil sorbent granules of the present invention that are formed of or from an extruded oil sorbent pellet 48 and/or 48′ where sorghum is used as the starch-containing material in the starch-containing mixture, the starch-containing mixture from which the oil sorbent pellets 48 and/or 48′ are extruded preferably has a moisture content no greater than 20% and preferably no greater than 18%.

The starch-based admixture can also contain cellulosic material, such as in the form of cellulosic fiber, e.g., plant fiber, hemp, wood fiber, sawdust, or another source of cellulose and/or hemicellulose, in an amount no greater than 40% by dry admixture weight, e.g. before any water is added, preferably no greater than 35% by dry admixture weight, and more preferably no greater than 30% by dry admixture weight. Where the admixture contains cellulosic material, the use of such cellulosic material preferably helps facilitate adsorption of oil coming in contact with an oil sorbent granule formed of or from such a cellulose containing extruded pellet 48 and/or 48′ during sorbent use while also helping provide structural support to each oil sorbent pellet 48 and/or 48′ extruded therefrom.

Preferred sources of starch used in the extrusion admixture include starch from one or more cereal grains, such as from one or more of corn, maize, sorghum, rice, wheat, barley, rye, triticale, buckwheat, fonio, and/or quinoa, which can be comminuted into flour, meal, grits, and/or starch as known in the art. A preferred admixture is at least partially or substantially completely composed of one or more whole grain cereal grains, such as one or more of corn, maize, sorghum, rice, wheat, barley, rye, triticale, buckwheat, fonio, and/or quinoa, extruded in their whole grain form to produce oil sorbent pellets 48.

In one preferred admixture and method of extruding oil sorbent pellets 48 and/or 48′ in accordance with the present invention, whole grain sorghum kernels, which can be degermed or in a degermed form, are used in the admixture and enter the extruder in their whole grain kernel form. In another preferred admixture and method, whole grain corn kernels, which can be degermed or in a degermed form, are used in the admixture and enter the extruder in their whole grain kernel form. Where such a whole grain sorghum admixture is used, it has a moisture content no greater than 20% by admixture weight and preferably has a moisture content no greater than 18% by admixture weight.

The admixture is extruded by a single screw or twin screw extruder at an extruder exit die temperature(s) and extruder exit die pressure(s) sufficient to not only form oil sorbent pellets 48 and/or 48′ each containing starch but which also produces such pellets 48 and/or 48′ which preferably are also porous and/or which preferably also have an internal void filled or pocket filled starch matrix pellet structure that increases the amount of oil that each pellet 48 and/or 48′ and/or each oil sorbent granule formed of or therefrom can hold. Such a void filled internal starch matrix structure formed in each pellet 48 and/or 48′ by or during pellet extrusion advantageously acts as a sponge which helps not only more quickly adsorb oil during oil sorbent use but which also helps pick up a greater amount of oil during oil sorbent use. In a preferred plant or flora pellet extrusion method, the admixture is extruded by the extruder at an extruder temperature and pressure sufficient to at least partially expand or puff each pellet 48 and/or 48′ to form pellets 48 and/or 48′ each having such outer surface porosity and void filled starch matrix.

Where one or more oil sorbent granules of a granular oil sorbent 42 of the present invention is formulated to include one or more types or strains of bacteria and/or fungi used to break down oil when used in an oil sorbent remediation application, e.g. to treat or cleanup an oil spill, the starch present in each pellet 48 and/or 48′ advantageously also provides a source of food for the bacteria and/or fungi carried thereby that helps facilitate their growth and distribution when applied during such remediation treatment. In one preferred granular oil sorbent 42 of the present invention, the sorbent 42 contains at least a plurality, preferably at least a plurality of pairs, i.e. at least three, oil sorbent granules 44 formed of or from extruded pellets 48 and/or 48′ which have been extruded with one or more types or strains of such oil digesting bacteria and/or fungi and/or which have been externally treated with one or more types or strains of such oil digesting bacteria and/or fungi during or after extrusion.

In a preferred method of making oil sorbent pellets 48 and/or 48′, the admixture is extruded by the extruder at an extruder temperature and pressure sufficient not only to form porous and void filled pellets 48 and/or 48′, but also to physically and/or thermally modify at least some of the starch present in the admixture during extrusion to form liquid-soluble starch-based or starch-containing material in each pellet 48 and/or 48′ which can and preferably does dissolve and/or flow when wetted with a liquid during sorbent use thereby facilitating oil sorption as a result. In those portions of such oil sorbent pellets 48 and/or 48′ containing liquid soluble material formed therein by or during extrusion, wetting of the pellets 48 and/or 48′ and/or oil sorbent granules 44 formed of or therefrom causes at least some of the liquid soluble material to dissolve and flow therefrom creating openings, enlarging pores, and/or exposing the internal void filled starch matrix enabling oil in contact therewith with to be more readily adsorbed therein. As a result, not only is the rate or speed at which oil adsorption or pickup takes place increased, but also the amount or capacity each such liquid soluble material containing pellet 48 and/or pellet 48′ and/or oil sorbent granule 44 formed of or therefrom also advantageously is increased.

In one such preferred method of making oil sorbent pellets 48 and/or 48′, the admixture is extruded by the extruder at an extruder temperature and pressure sufficient not only to form porous and void filled pellets 48 and/or 48′, but also to physically and/or thermally modify at least some of the starch present in the admixture during extrusion to form water-soluble starch-based or starch-containing material in each pellet 48 and/or 48′ which dissolves and/or flows when wetted with an aqueous liquid during sorbent use thereby facilitating oil sorption as a result. In those portions of such oil sorbent pellets 48 and/or 48′ containing water soluble material formed therein by or during extrusion, wetting of the pellets 48 and/or 48′ and/or oil sorbent granules 44 formed of or therefrom causes at least some of the water soluble material to dissolve and flow therefrom creating openings, enlarging pores, and/or exposing the internal void filled starch matrix enabling oil in contact therewith with to be more readily adsorbed therein. As a result, not only is the rate or speed at which oil adsorption or pickup takes place increased, but also the amount or capacity each such water soluble material containing pellet 48 and/or pellet 48′ and/or oil sorbent granule 44 formed of or therefrom also advantageously is increased.

In another such preferred method of making oil sorbent pellets 48 and/or 48′, the admixture is extruded by the extruder at an extruder temperature and pressure sufficient not only to form porous and void filled pellets 48 and/or 48′, but also to physically and/or thermally modify at least some of the starch present in the admixture during extrusion to form liquid-soluble binder in each pellet 48 and/or 48′ which can facilitate agglutination of pellets 48 and/or 48′ and/or oil sorbent granules 44 formed of or therefrom when wetted with a liquid during sorbent use. Wetting of such liquid soluble binder containing pellets 48 and/or 48′ and/or oil sorbent granules 44 formed of or therefrom causes them to become at least slightly tacky or sticky advantageously helping them to agglutinate by adhering to adjacent pellets 48 and/or 48′ and/or oil sorbent granules 44 formed of or therefrom during oil sorbent use. As a result of wetted pellets 48 and/or 48′ and/or oil sorbent granules 44 formed of or therefrom clinging or adhering together during agglutination when wetted, pickup of spent or used pellets 48 and/or 48′ and/or spent or used oil sorbent granules 44 formed of or therefrom can more easily be picked up and disposed of following oil sorbent use.

In still another such preferred method of making oil sorbent pellets 48 and/or 48′, the admixture is extruded by the extruder at an extruder temperature and pressure sufficient not only to form porous and void filled pellets 48 and/or 48′, but also to physically and/or thermally modify at least some of the starch present in the admixture during extrusion to form water-soluble binder in each pellet 48 and/or 48′ which can facilitate agglutination of pellets 48 and/or 48′ and/or oil sorbent granules 44 formed of or therefrom when wetted with an aqueous liquid during sorbent use. Wetting of such water soluble binder containing pellets 48 and/or 48′ and/or oil sorbent granules 44 formed of or therefrom causes them to become at least slightly tacky or sticky advantageously helping them to agglutinate by adhering to adjacent pellets 48 and/or 48′ and/or oil sorbent granules 44 formed of or therefrom during oil sorbent use. As a result of wetted pellets 48 and/or 48′ and/or oil sorbent granules 44 formed of or therefrom clinging or adhering together during agglutination when wetted, pickup of spent or used pellets 48 and/or 48′ and/or spent or used oil sorbent granules 44 formed of or therefrom can more easily be picked up and disposed of following oil sorbent use.

In one such preferred method of making oil sorbent pellets 48 and/or 48′, such a starch-containing admixture is extruded by the extruder at an extruder temperature and pressure sufficient to also form water soluble binder in each extruded pellet 48 and/or 48′ in an amount sufficient to at least lightly adhere pellets 48 and/or 48′ and/or oil sorbent granules 44 formed of or therefrom to one another as well as to other non-extruded granules and/or particles when wetted with water or another aqueous liquid making it easier to pick up and dispose of following oil sorbent use. In one preferred method of use, an aqueous liquid, e.g. water, is applied to pellets 48 and/or 48′ and/or oil sorbent granules 44 formed of or therefrom of granular oil sorbent 42 of the present invention after the pellets 48 and/or 48′ and/or oil sorbent granules 44 formed of or therefrom have adsorbed oil to cause at least a plurality of pairs, i.e., at least three, of the pellets 48 and/or 48′ and/or oil sorbent granules 44 formed of or therefrom to agglutinate or at least lightly cling together making them easier to pick up and dispose once they are spent during or after oil sorbent use. In another preferred method of use, an aqueous liquid, e.g. water, is applied to pellets 48 and/or 48′ and/or oil sorbent granules 44 formed of or therefrom of granular oil sorbent 42 of the present invention after the pellets 48 and/or 48′ and/or oil sorbent granules 44 formed of or therefrom have adsorbed oil to cause to cause at least a plurality of pairs, i.e., at least three, of the pellets 48 and/or 48′ and/or oil sorbent granules 44 formed of or therefrom to not only agglutinate but also to clump together and form a hardened clump, preferably forming a hard or solid clump, after curing or drying of the binder thereby forming a solid clump that also makes it easier to pick up and dispose of following oil sorbent use.

In one preferred method, the admixture is extruded by the extruder at an extruder temperature and pressure sufficient to form water soluble binder in each extruded oil sorbent pellet 48 and/or 48′, preferably cold water soluble binder that is water soluble at room temperatures, e.g. water soluble at temperatures between 59° F. and 77° F. or between 15° C. and 25° F., which at least partially dissolves or solubilizes when wetted with an aqueous liquid, e.g. water, in forming an amount of wetted adhesive sufficient to become tacky or sticky and at least lightly adhere to or with one or more adjacent pellets 48 and/or 48′ and/or oil sorbent granules 44 formed of or therefrom forming an agglutinated mass containing at least a plurality of pairs, i.e. at least three, of pellets 48 and/or 48′ and/or granules 44 that cling together and are easy to pick up and remove together. In one such preferred method, the admixture is extruded by the extruder at an extruder temperature and pressure sufficient to form water soluble binder in each extruded oil sorbent pellet 48 and/or 48′, preferably cold water soluble binder, in an amount sufficient to form flowable adhesive when wetted that flows from, around, onto and/or in between wetted pellets 48 and/or 48′ (and/or granules 44) and/or to other non-extruded granules and/or non-extruded particles of granular oil sorbent of the present invention, with the amount of such flowable adhesive formed sufficient to at least at least lightly adhere pellets 48 and/or 48′ and/or granules 44 to one another and/or to non-extruded granules and/or non-extruded particles of the granular oil sorbent during oil sorbent use. In one such preferred method, the admixture is extruded by the extruder at an extruder temperature and pressure sufficient to form water soluble binder in each pellet 48 and/or 48′ and/or granule 44, preferably cold water soluble binder, in an amount sufficient to produce flowable adhesive that flows from, around, onto and/or in between pellets 48 and/or 48′ and/or granules 44 when wetted with an aqueous liquid, e.g. water, which firmly and/or strongly binds at least a plurality of pairs, i.e. at least three, of the pellets 48 and/or 48′ and/or granules 44 formed of or therefrom forming a clump that preferably hardens to become solid enabling the clump to be easily removed.

In a preferred method of extruded granular oil sorbent use, during and preferably after application of granular oil sorbent 42 onto a remediation area containing oil to be treated or remediated, an aqueous liquid, e.g. water, is applied to cause water soluble binder in at least a plurality, preferably at least a plurality of pairs, i.e. at least three, of oil sorbent pellets 48 and/or 48′ and/or oil sorbent granules 44 formed of or therefrom of the oil sorbent 42 to make them at least become tacky or sticky causing at least a plurality, preferably at least a plurality of pairs, i.e., at least three, of oil sorbent pellets 48 and/or 48′ and/or oil sorbent granules 44 to agglutinate or adhere to one another after each has picked up at least some oil producing an agglutinated mass formed of at least a plurality of pairs, i.e., at least three, of oil sorbent pellets 48 and/or 48′ and/or granules 44. In other words, the application of an aqueous liquid, e.g. water, onto at least partially spent pellets 48 and/or 48′ and/or granules 44 that have been applied onto such an oil containing remediation area and which have picked up at least some oil facilitates faster, cleaner and more convenient pickup of spent granular oil sorbent because application of the an aqueous liquid, e.g. water, causes them to at least lightly adhere to one another or agglutinate into a larger mass of pellets 48 and/or 48′ and/or granules 44 that is easier to remove from the remediation area. In one such preferred method of granular oil absorbent use, an aqueous liquid, e.g. water, is applied onto granular oil sorbent 42 of the present invention after the granular oil sorbent 42 has been applied onto such a remediation area and pellets 48 and/or 48′ and/or granules 44 of the sorbent 42 have adsorbed or picked up at least some of the oil to be remediated. Preferably, in carrying out such a preferred method of use, granular oil sorbent 42 is applied onto the remediation site long enough for at least a plurality, preferably at least a plurality of pairs, i.e. at least three, of the pellets 48 and/or 48′ and/or granules 44 have picked up a substantial amount of oil preferably each becoming substantially completely saturated with oil before an aqueous liquid, e.g. water, is applied in an agglutinating or clumping step. Application of an aqueous liquid, e.g. water, onto the oil containing pellets 48 and/or 48′ and/or oil sorbent granules 44 causes water soluble binder therein to adhere them together forming an agglutinated mass of at least a plurality of pairs, i.e. at least three of the spent pellets 48 and/or 48′ and/or oil sorbent granules 44. As the water evaporates from the mass of pellets 48 and/or 48′ and/or granules 44, the mass can cure and harden forming a substantially solid or hardened clump that is thereafter easy to pick up and remove from the site of the oil.

In another preferred method of granular oil sorbent use, application of an aqueous liquid, e.g. water, onto oil-containing pellets 48 and/or 48′ and/or oil-containing sorbent granules 44 of granular oil sorbent 42 of the present invention causes water soluble binder in the wetted oil-holding or spent pellets 48 and/or 48′ and/or oil-holding or spent granules 44 to form flowable adhesive that flows therefrom, around, onto and/or in between at least a plurality, preferably at least a plurality of pairs, i.e., at least three, of the oil-holding or spent pellets 48 and/or 48′ and/or oil-holding or spent granules 44 firmly adhering them together forming a clump of at least a plurality of pairs, i.e. at least three of the oil-holding or spent pellets 48 and/or 48′ and/or oil-holding or spent granules 44. As the water evaporates from the clump of pellets 48 and/or 48′ and/or granules 44, the clump cures and/or hardens preferably becoming a substantially solid or hardened clump that is thereafter easy to pick up and remove from the site of the oil.

In a preferred oil sorbent pellet extrusion method, the admixture is extruded from the extruder, preferably a single screw extruder, at an extrusion temperature of at least 100° C. in the extrusion die and at an extrusion pressure of at least 2000 pounds per square inch at the extrusion die providing an extrusion temperature and pressure sufficient to physically and/or thermally modify starch in the admixture to form such water soluble binder, preferably cold water soluble binder, and more preferably amylopectin cold water soluble binder, in each pellet 48 and/or 48′ in an amount sufficient to agglutinate and preferably even clump pellets 48 and/or 48′ and/or oil sorbent granules 44 formed of or therefrom when wetted with an aqueous liquid, e.g. water, during oil sorbent use. In one such preferred oil sorbent pellet extrusion method, extruding such an admixture under such extruder operating parameters and conditions forms on enough water-soluble binder in each extruded oil sorbent pellet 48 and/or 48′ that pellets 48 and/or 48′ and/or granules 44 of granular oil sorbent 42 of the present invention produce enough such flowable adhesive when wetted with an aqueous liquid, e.g. water, to produce one or more clumps each formed of at least a plurality, preferably at least a plurality of pairs, i.e. at least three, of pellets 48 and/or 48′ and/or granules 44 that becomes substantially solid or hard when dried.

In one preferred pellet extrusion method, the admixture is extruded from the extruder, preferably a single screw extruder, at an extrusion temperature of at least 100° C. at the extrusion die and at an extrusion pressure of at least 2000 pounds per square inch to produce pellets 48 and/or 48′ each having at least 5% water soluble binder, preferably cold water soluble binder, and more preferably amylopectin cold water soluble binder, which makes each pellet 48 and/or 48′ and/or granule 44 formed of or therefrom sticky or tacky enough for one or more other pellets 48 and/or 48′, granules 44 formed of or therefrom, and/or non-extruded granules and/or non-extruded particles of granular oil sorbent 42 to at least lightly adhere together or agglutinate into a more easily removable mass formed of at least a plurality, preferably at least a plurality, of pairs of pellets 48 and/or 48′, and/or granules 44. In one such preferred pellet extrusion method, extruding such an admixture under such extruder operating parameters and conditions physically and/or thermally modify starch in the admixture forming at least at least 5% water soluble binder, preferably cold water soluble binder, and more preferably amylopectin cold water soluble binder in each pellet 48 and/or 48′ that turns into a flowable adhesive when wetted with water that is preferably sufficient not only to adhere them, bind them and/or clump them together with one or more other pellets 48 and/or 48′ and/or granules 44, but which also forms substantially solid clumps thereof after sorbent use that are easily picked up and disposed of.

In such a preferred pellet extrusion method, water soluble binder, preferably cold water soluble binder, and more preferably amylopectin cold water soluble binder, is formed in each pellet 48 and/48′ from starch in the admixture in such an amount sufficient to cause wetted pellets 48 and/or 48′ and/or granules 44 to adhere together, agglutinate, and/or form hard clumps without any other binder being present in the admixture. Such a sufficient amount of water soluble binder in each pellet 48 and/or 48′ and/or granules 44 formed of or therefrom advantageously enables them to bind with each other and any other non-extruded granules and/or non-extruded particles of granular oil sorbent 42 of the present invention when applied to a remediation site, e.g. oil spill, and wetted.

In another preferred oil sorbent pellet extrusion method, the admixture is extruded from the extruder, preferably a single screw extruder, at an extrusion temperature of at least 100° C. at the extrusion die and at an extrusion pressure of at least 2000 pounds per square inch to produce pellets 48 and/or 48′ each having at least 7% water soluble binder, preferably cold water soluble binder, and more preferably amylopectin cold water soluble binder, which is sufficient to not only adhere wetted pellets 48 and/or 48′ together but which preferably also is sufficient to form flowable adhesive when the pellets 48 and/or 48′ are wetted with water sufficient to adhere them, bind them and/or clump them together and/or to one or more other particles or granules. In still another preferred pellet extrusion method, the admixture is extruded from the extruder, preferably a single screw extruder, at an extrusion temperature of at least 100° C. at the extrusion die and at an extrusion pressure of at least 2500 pounds per square inch to produce pellets 48 and/or 48′ each having at least 10% water soluble binder, preferably cold water soluble binder, and more preferably amylopectin cold water soluble binder, which is sufficient to not only adhere wetted pellets 48 and/or 48′ together but which preferably also is sufficient to form flowable adhesive when the pellets 48 and/or 48′ are wetted with water sufficient to adhere them, bind them and/or clump them together and/or to one or more other particles or granules. In a further preferred pellet extrusion method, the admixture is extruded from the extruder, preferably a single screw extruder, at an extrusion temperature of at least 100° C. at the extrusion die and at an extrusion pressure of at least 2500 pounds per square inch to produce pellets 48 and/or 48′ each having at least 12% water soluble binder, preferably cold water soluble binder, and more preferably amylopectin cold water soluble binder, which is sufficient to not only adhere wetted pellets 48 and/or 48′ together but which preferably also is sufficient to form flowable adhesive when the pellets 48 and/or 48′ are wetted with water sufficient to adhere them, bind them and/or clump them together and/or to one or more other particles or granules. In yet another preferred pellet extrusion method, the admixture is extruded from the extruder, preferably a single screw extruder, at an extrusion temperature of at least 100° C. at the extrusion die and at an extrusion pressure of at least 2500 pounds per square inch to produce pellets 48 and/or 48′ each having at least 15% water soluble binder, preferably cold water soluble binder, and more preferably amylopectin cold water soluble binder, which is sufficient to not only adhere wetted pellets 48 and/or 48′ together but which preferably also is sufficient to form flowable adhesive when the pellets 48 and/or 48′ are wetted with water sufficient to adhere them, bind them and/or clump them together and/or to one or more other particles or granules. In another preferred pellet extrusion method, the admixture is extruded from the extruder, preferably a single screw extruder, at an extrusion temperature of at least 100° C. at the extrusion die and at an extrusion pressure of at least 2500 pounds per square inch to produce pellets 48 and/or 48′ each having at least 20% water soluble binder, preferably cold water soluble binder, and more preferably amylopectin cold water soluble binder, which is sufficient to not only adhere wetted pellets 48 and/or 48′ together but which preferably also is sufficient to form flowable adhesive when the pellets 48 and/or 48′ are wetted with water sufficient to adhere them, bind them and/or clump them together and/or to one or more other particles or granules.

In such a preferred oil sorbent pellet extrusion method, water soluble binder, preferably cold water soluble binder, and more preferably amylopectin cold water soluble binder, is formed in each pellet 48 and/48′ from starch in the admixture in such an amount sufficient to cause wetted pellets 48 and/or 48′ and/or granules 44 to adhere together, agglutinate, and/or form hard clumps without any other binder being present in the admixture. Such a sufficient amount of water soluble binder in each pellet 48 and/or 48′ and/or granules 44 formed of or therefrom advantageously enables them to bind with each other and any other non-extruded granules and/or non-extruded particles of granular oil sorbent 42 of the present invention when applied to a remediation site, e.g. oil spill, and wetted.

In still another preferred oil sorbent pellet extrusion method, the admixture is extruded from the extruder, preferably a single screw extruder, at an extrusion temperature of at least 100° C. at the extrusion die and at an extrusion pressure of at least 2500 pounds per square inch to produce pellets 48 and/or 48′ each having at least 7% water soluble binder, preferably cold water soluble binder, and more preferably amylopectin cold water soluble binder, which is sufficient to not only adhere wetted pellets 48 and/or 48′ together but which preferably also is sufficient to form flowable adhesive when the pellets 48 and/or 48′ are wetted with water sufficient to adhere them, bind them and/or clump them together and/or to one or more other particles or granules. In still another preferred pellet extrusion method, the admixture is extruded from the extruder, preferably a single screw extruder, at an extrusion temperature of at least 100° C. at the extrusion die and at an extrusion pressure of at least 2750 pounds per square inch to produce pellets 48 and/or 48′ each having at least 10% water soluble binder, preferably cold water soluble binder, and more preferably amylopectin cold water soluble binder, which is sufficient to not only adhere wetted pellets 48 and/or 48′ together but which preferably also is sufficient to form flowable adhesive when the pellets 48 and/or 48′ are wetted with water sufficient to adhere them, bind them and/or clump them together and/or to one or more other particles or granules. In a further preferred pellet extrusion method, the admixture is extruded from the extruder, preferably a single screw extruder, at an extrusion temperature of at least 100° C. at the extrusion die and at an extrusion pressure of at least 3000 pounds per square inch to produce pellets 48 and/or 48′ each having at least 12% water soluble binder, preferably cold water soluble binder, and more preferably amylopectin cold water soluble binder, which is sufficient to not only adhere wetted pellets 48 and/or 48′ together but which preferably also is sufficient to form flowable adhesive when the pellets 48 and/or 48′ are wetted with water sufficient to adhere them, bind them and/or clump them together and/or to one or more other particles or granules. In yet another preferred pellet extrusion method, the admixture is extruded from the extruder, preferably a single screw extruder, at an extrusion temperature of at least 100° C. at the extrusion die and at an extrusion pressure of at least 3250 pounds per square inch to produce pellets 48 and/or 48′ each having at least 15% water soluble binder, preferably cold water soluble binder, and more preferably amylopectin cold water soluble binder, which is sufficient to not only adhere wetted pellets 48 and/or 48′ together but which preferably also is sufficient to form flowable adhesive when the pellets 48 and/or 48′ are wetted with water sufficient to adhere them, bind them and/or clump them together and/or to one or more other particles or granules. In another preferred pellet extrusion method, the admixture is extruded from the extruder, preferably a single screw extruder, at an extrusion temperature of at least 100° C. at the extrusion die and at an extrusion pressure of at least 3500 pounds per square inch to produce pellets 48 and/or 48′ each having at least 20% water soluble binder, preferably cold water soluble binder, and more preferably amylopectin cold water soluble binder, which is sufficient to not only adhere wetted pellets 48 and/or 48′ together but which preferably also is sufficient to form flowable adhesive when the pellets 48 and/or 48′ are wetted with water sufficient to adhere them, bind them and/or clump them together and/or to one or more other particles or granules.

In such a preferred pellet extrusion method, water soluble binder, preferably cold water soluble binder, and more preferably amylopectin cold water soluble binder, is formed in each pellet 48 and/48′ from starch in the admixture in such an amount sufficient to cause wetted pellets 48 and/or 48′ and/or granules 44 to adhere together, agglutinate, and/or form hard clumps without any other binder being present in the admixture. Such a sufficient amount of water soluble binder in each pellet 48 and/or 48′ and/or granules 44 formed of or therefrom advantageously enables them to bind with each other and any other non-extruded granules and/or non-extruded particles of granular oil sorbent 42 of the present invention when applied to a remediation site, e.g. oil spill, and wetted.

In yet another preferred oil sorbent pellet extrusion method, an admixture composed substantially completely of sorghum, preferably composed of at least 70% sorghum, is extruded from the extruder, preferably a single screw extruder, at an extrusion temperature of at least 100° C. at the extrusion die and at an extrusion pressure of at least 2500 pounds per square inch to produce pellets 48 and/or 48′ each having at least 7% water soluble binder, preferably cold water soluble binder, and more preferably amylopectin cold water soluble binder, which is sufficient to not only adhere wetted pellets 48 and/or 48′ together but which preferably also is sufficient to form flowable adhesive when the pellets 48 and/or 48′ are wetted with water sufficient to adhere them, bind them and/or clump them together and/or to one or more other particles or granules. In another preferred pellet extrusion method, an admixture composed substantially completely of sorghum, preferably composed of at least 70% sorghum, preferably whole grain sorghum, is extruded from the extruder, preferably a single screw extruder, at an extrusion temperature of at least 100° C. at the extrusion die and at an extrusion pressure of at least 2750 pounds per square inch to produce pellets 48 and/or 48′ each having at least 10% water soluble binder, preferably cold water soluble binder, and more preferably amylopectin cold water soluble binder, which is sufficient to not only adhere wetted pellets 48 and/or 48′ together but which preferably also is sufficient to form flowable adhesive when the pellets 48 and/or 48′ are wetted with water sufficient to adhere them, bind them and/or clump them together and/or to one or more other particles or granules. In a further preferred pellet extrusion method an admixture composed substantially completely of sorghum, preferably composed of at least 65% sorghum, preferably whole grain sorghum, is extruded from the extruder, preferably a single screw extruder, at an extrusion temperature of at least 100° C. at the extrusion die and at an extrusion pressure of at least 3000 pounds per square inch to produce pellets 48 and/or 48′ each having at least 12% water soluble binder, preferably cold water soluble binder, and more preferably amylopectin cold water soluble binder, which is sufficient to not only adhere wetted pellets 48 and/or 48′ together but which preferably also is sufficient to form flowable adhesive when the pellets 48 and/or 48′ are wetted with water sufficient to adhere them, bind them and/or clump them together and/or to one or more other particles or granules. In yet another preferred pellet extrusion method, an admixture composed substantially completely of sorghum, preferably composed of at least 60% sorghum, preferably whole grain sorghum, is extruded from the extruder, preferably a single screw extruder, at an extrusion temperature of at least 100° C. at the extrusion die and at an extrusion pressure of at least 3250 pounds per square inch to produce pellets 48 and/or 48′ each having at least 15% water soluble binder, preferably cold water soluble binder, and more preferably amylopectin cold water soluble binder, which is sufficient to not only adhere wetted pellets 48 and/or 48′ together but which preferably also is sufficient to form flowable adhesive when the pellets 48 and/or 48′ are wetted with water sufficient to adhere them, bind them and/or clump them together and/or to one or more other particles or granules. In yet still another preferred pellet extrusion method, an admixture composed substantially completely of sorghum, preferably composed of at least 60% sorghum, preferably whole grain sorghum, is extruded from the extruder, preferably a single screw extruder, at an extrusion temperature of at least 100° C. at the extrusion die and at an extrusion pressure of at least 3500 pounds per square inch to produce pellets 48 and/or 48′ each having at least 20% water soluble binder, preferably cold water soluble binder, and more preferably amylopectin cold water soluble binder, which is sufficient to not only adhere wetted pellets 48 and/or 48′ together but which preferably also is sufficient to form flowable adhesive when the pellets 48 and/or 48′ are wetted with water sufficient to adhere them, bind them and/or clump them together and/or to one or more other particles or granules.

In such a preferred pellet extrusion method, water soluble binder, preferably cold water soluble binder, and more preferably amylopectin cold water soluble binder, is formed in each pellet 48 and/48′ from starch in the admixture in such an amount sufficient to cause wetted pellets 48 and/or 48′ and/or granules 44 to adhere together, agglutinate, and/or form hard clumps without any other binder being present in the admixture. Such a sufficient amount of water soluble binder in each pellet 48 and/or 48′ and/or granules 44 formed of or therefrom advantageously enables them to bind with each other and any other non-extruded granules and/or non-extruded particles of granular oil sorbent 42 of the present invention when applied to a remediation site, e.g. oil spill, and wetted.

In a further preferred pellet extrusion method, an admixture composed substantially completely of corn, preferably composed of at least 60% corn, is extruded from the extruder, preferably a single screw extruder, at an extrusion temperature of at least 100° C. at the extrusion die and at an extrusion pressure of at least 2500 pounds per square inch to produce pellets 48 and/or 48′ each having at least 7% water soluble binder, preferably cold water soluble binder, and more preferably amylopectin cold water soluble binder, which is sufficient to not only adhere wetted pellets 48 and/or 48′ together but which preferably also is sufficient to form flowable adhesive when the pellets 48 and/or 48′ are wetted with water sufficient to adhere them, bind them and/or clump them together and/or to one or more other particles or granules. In another preferred pellet extrusion method, an admixture composed substantially completely of corn, preferably composed of at least 60% corn, preferably in cornmeal form, is extruded from the extruder, preferably a single screw extruder, at an extrusion temperature of at least 100° C. at the extrusion die and at an extrusion pressure of at least 2750 pounds per square inch to produce pellets 48 and/or 48′ each having at least 10% water soluble binder, preferably cold water soluble binder, and more preferably amylopectin cold water soluble binder, which is sufficient to not only adhere wetted pellets 48 and/or 48′ together but which preferably also is sufficient to form flowable adhesive when the pellets 48 and/or 48′ are wetted with water sufficient to adhere them, bind them and/or clump them together and/or to one or more other particles or granules. In a further preferred pellet extrusion method an admixture composed substantially completely of corn, preferably composed of at least 60% corn, preferably cornmeal, is extruded from the extruder, preferably a single screw extruder, at an extrusion temperature of at least 100° C. at the extrusion die and at an extrusion pressure of at least 3000 pounds per square inch to produce pellets 48 and/or 48′ each having at least 12% water soluble binder, preferably cold water soluble binder, and more preferably amylopectin cold water soluble binder, which is sufficient to not only adhere wetted pellets 48 and/or 48′ together but which preferably also is sufficient to form flowable adhesive when the pellets 48 and/or 48′ are wetted with water sufficient to adhere them, bind them and/or clump them together and/or to one or more other particles or granules. In yet another preferred pellet extrusion method, an admixture composed substantially completely of corn, preferably composed of at least 50% corn, preferably cornmeal, is extruded from the extruder, preferably a single screw extruder, at an extrusion temperature of at least 100° C. at the extrusion die and at an extrusion pressure of at least 3250 pounds per square inch to produce pellets 48 and/or 48′ each having at least 15% water soluble binder, preferably cold water soluble binder, and more preferably amylopectin cold water soluble binder, which is sufficient to not only adhere wetted pellets 48 and/or 48′ together but which preferably also is sufficient to form flowable adhesive when the pellets 48 and/or 48′ are wetted with water sufficient to adhere them, bind them and/or clump them together and/or to one or more other particles or granules. In yet still another preferred pellet extrusion method, an admixture composed substantially completely of corn, preferably composed of at least 50% corn, preferably cornmeal, is extruded from the extruder, preferably a single screw extruder, at an extrusion temperature of at least 100° C. at the extrusion die and at an extrusion pressure of at least 3500 pounds per square inch to produce pellets 48 and/or 48′ each having at least 20% water soluble binder, preferably cold water soluble binder, and more preferably amylopectin cold water soluble binder, which is sufficient to not only adhere wetted pellets 48 and/or 48′ together but which preferably also is sufficient to form flowable adhesive when the pellets 48 and/or 48′ are wetted with water sufficient to adhere them, bind them and/or clump them together and/or to one or more other particles or granules

In such a preferred oil sorbent pellet extrusion method, water soluble binder, preferably cold water soluble binder, and more preferably amylopectin cold water soluble binder, is formed in each pellet 48 and/48′ from starch in the admixture in such an amount sufficient to cause wetted pellets 48 and/or 48′ and/or granules 44 to adhere together, agglutinate, and/or form hard clumps without any other binder being present in the admixture. Such a sufficient amount of water soluble binder in each pellet 48 and/or 48′ and/or granules 44 formed of or therefrom advantageously enables them to bind with each other and any other non-extruded granules and/or non-extruded particles of granular oil sorbent 42 of the present invention when applied to a remediation site, e.g. oil spill, and wetted.

In a preferred method of making extruded oil sorbent pellets 48 and/or 48′ of the present invention, immediately upon or after extrusion of the oil sorbent pellets 48 and/or 48′, the pellets 48 and/or 48′ are air quenched substantially simultaneously upon extrusion thereby flash drying the pellets 48 and/or 48′ without application of heat setting and/or preserving the highly amorphous structure of the cold water soluble amylopectin amylose/starch binder formed in each granule/pellet. Such air quenching cold flash drying of pellets 48 and/or 48′ as they are exiting the extruder die and being cut into individual pellets 48 and/or 48′ thereby sets and/or preserves the highly amorphous structure of the cold water soluble amylopectin starch binder formed in each pellet 48 and/or 48′ via physical and/or thermal starch modification during gelatinization and/or extrusion from the extruder. By air quenching and/or cold flash air drying of the pellets 48 and/or 48′ as they are exiting the extruder in this manner, highly amorphous amylopectin amylose/starch molecules and/or structure formed in each extruded pellet 48 and/or 48′ is substantially instantly set or preserved preventing crystallization and/or retrogradation of the amylopectin amylose/starch would otherwise normally occur if not air quenched and/or cold flash air dried.

Air quenching also inhibits retrogradation and preferably substantially completely prevents retrogradation of pellets 48 and/or 48′ from taking place producing pellets 48 and/or 48′ that are stable in that the pellets 48 and/or 48′ do not retrograde when kept at room temperature. In a preferred granular sorbent embodiment and method of making extruded granular sorbent in accordance with that disclosed herein, air quenching inhibits retrogradation and preferably substantially completely prevents retrogradation of pellets 48 and/or 48′ from taking place producing pellets or granules that are stable in that the pellets 48 and/or 48′ do not retrograde when kept below 100 degrees Fahrenheit. In still another preferred granular sorbent embodiment and method of making extruded granular sorbent in accordance with that disclosed herein, air quenching inhibits retrogradation and preferably substantially completely prevents retrogradation of pellets 48 and/or 48′ from taking place producing organic oil sorbent pellets 48 and/or 48′ that are stable in that the pellets 48 and/or 48′ do not retrograde when kept below 90 degrees Fahrenheit. In a further preferred granular sorbent embodiment and method of making extruded granular sorbent in accordance with that disclosed herein, air quenching inhibits retrogradation and preferably substantially completely prevents retrogradation of pellets 48 and/or 48′ from taking place producing pellets 48 and/or 48′ that are stable in that the pellets or granules do not retrograde when kept below 80 degrees Fahrenheit.

In a preferred embodiment, the extruder is equipped with an air pressurized extruder head box connected to a supply of air that can be pressurized and which preferably is introduced into the head box at a volumetric flow rate sufficiently high enough to substantially instantly set the state of physically or thermally modified starch cold water soluble binder formed in each pellets 48 and/or 48′ as it is being extruded from the extruder die so that the cold water soluble binder is completely preserved in a highly amorphous state and/or in a highly amorphous structure. This advantageously produces sufficient cold water soluble binder in extruded organic oil sorbent pellet 48 and/or 48′ in accordance with at least one or more of the water soluble binder weight percentages disclosed herein.

In one preferred embodiment, at least 1000 ft.³ per minute of air at room temperature is introduced into the head box and can be directed at or generally toward the extruder die opening from which the organic oil sorbent pellets 48 and/or 48′ are extruded air quenching the pellets as they exit the extruder. In another preferred embodiment, at least 1250 ft.³ per minute of air at room temperature is introduced into the head box and can be directed at or generally toward the extruder die opening from which the pellets 48 and/or 48′ are extruded air quenching the pellets as they exit the extruder. In still another preferred embodiment, at least 1500 ft.³ per minute of air at room temperature is introduced into the head box and can be directed at or generally toward the extruder die opening from which pellets 48 and/or 48′ are extruded. In yet another preferred embodiment, at least 1750 ft.³ per minute of air at room temperature is introduced into the head box and can be directed at or generally toward the extruder die opening from which the pellets 48 and/or 48′ are extruded air quenching the pellets as they exit the extruder. In still yet another preferred embodiment, at least 2000 ft.³ per minute of air at room temperature is introduced into the head box and can be directed at or generally toward the extruder die opening from which pellets 48 and/or 48′ are extruded. In one preferred embodiment, at least 2100 ft.³ per minute of air at room temperature is introduced into the head box and can be directed at or generally toward the extruder die opening from which pellets 48 and/or 48′ are extruded. In another preferred embodiment, at least 2200 ft.³ per minute of air at room temperature is introduced into the head box and can be directed at or generally toward the extruder die opening from which the pellets 48 and/or 48′ are extruded. In still another preferred embodiment, at least 2500 ft.³ per minute of air at room temperature is introduced into the head box and can be directed at or generally toward the extruder die opening from which the pellets 48 and/or 48′ are extruded. In yet another preferred embodiment, at least 2750 ft.³ per minute of air at room temperature is introduced into the head box and can be directed at or generally toward the extruder die opening from which the pellets 48 and/or 48′ are extruded. In still yet another preferred embodiment, at least 3000 ft.³ per minute of air at room temperature is introduced into the head box and can be directed at or generally toward the extruder die opening from which the pellets 48 and/or 48′ are extruded. In a further preferred embodiment, at least 3250 ft.³ per minute of air at room temperature is introduced into the head box and can be directed at or generally toward the extruder die opening from which the pellets 48 and/or 48′ are extruded. In still yet another preferred embodiment, at least 3500 ft.³ per minute of air at room temperature is introduced into the head box and can be directed at or generally toward the extruder die opening from which the pellets 48 and/or 48′ are extruded air quenching the pellets as they exit the extruder. In yet another preferred embodiment, at least 3750 ft.³ per minute of air at room temperature is introduced into the head box and can be directed at or generally toward the extruder die opening from which the pellets 48 and/or 48′ are extruded. In still yet another preferred embodiment, at least 4000 ft.³ per minute of air at room temperature is introduced into the head box and can be directed at or generally toward the extruder die opening from which the pellets 48 and/or 48′ are extruded air quenching the pellets as they exit the extruder.

If desired, the extruder head box can be substantially air tightly sealed to facilitate pressurization and/or turbulent flow of the air introduced into the head box that is used to cold air flash dry each pellet 48 and/or 48′ substantially instantaneously upon extrusion from the extruder die. This rapidly freezes or sets at least some of the physically or thermally modified starch in each pellet 48 and/or 48′ into a cold water soluble form of binder that preferably substantially instantaneously dissolves or solubilizes when wetted with liquid, preferably water. In at least one preferred embodiment, at least some of the starch in each pellet 48 and/or 48′ whose form or structure is frozen, set or otherwise preserved by cold flash air drying of the pellets 48 and/or 48′ being discharged from the extruder die is frozen, set or otherwise preserved in an oil soluble and/or water insoluble/immiscible liquid soluble form or structure.

In a preferred air pressurized extruder head box cold air quenched and/or cold air flash dry system and method, a cyclone, e.g. cyclone fan, such as a fan, blower or the like capable of outputting at least 2000 ft.³ per minute and which preferably can output at least 3000 ft.³ per minute introduces turbulently flowing air (at or within ±15° C. of room temperature) into the head box thereby pressurizing the head box above ambient pressure. In one preferred embodiment, an air pressurized extruder head box is used with a 4080 ft.³ per minute free fan introducing at least 2500 ft.³ per minute and preferably at least 2725 ft.³ per minute at a 1.7 static pressure into the head box. Preferably, the turbulently flowing air passes through one or more filters before being introduced into the head box. A duct, tube or the like is connected to the fan or blower and serves as a conduit to direct air therefrom to the head box preferably after being filtered by the one or more filters. The duct, tube or the like has an opening that can be disposed adjacent the extruder die opening in order to direct turbulently flowing air toward the die opening and against pellet 48 and/or 48's as they are being extruded from the die.

In one preferred embodiment, a great enough volumetric flow of air is introduced into the head box that is sufficient to turbulently and convectively flash dry the organic oil sorbent pellets 48 and/or 48′ as they are being extruded from the extruder die without directing air directly at the extruder die opening. In another preferred embodiment, an opening of the duct, tube or other conduit is disposed adjacent the die opening such that air discharge therefrom into the head box impinges against the pellets 48 and/or 48′ as they are discharged from the extruder die thereby flash air drying the pellets 48 and/or 48′ freezing the form of any starch-based binder formed in the pellets 48 and/or 48′ in such a cold water soluble state and/or oil soluble state. In still another preferred embodiment, the opening of the duct, tube or other conduit is directed toward the extruder die opening and can include a flow directing nozzle whereby turbulently blowing air convectively cools the pellets 48 and/or 48′ immediately upon extrusion out the die opening air quenching and flash air drying the pellets 48 and/or 48′ helping to preserve and optimize not only the amount of water soluble material, preferably cold water soluble binder, formed in each pellet 48 and/or 48′ but also helping to optimize its oil adsorption capacity. The result of air quenching or flash drying each extruded organic oil sorbent pellet 48 and/or 48′ of the present invention helps preserve the state of the starch matrix interior of each pellet 48 and/or 48′ thereby helping to maximize the oil adsorption capacity of each pellet 48 and/or 48′

Each extruded oil sorbent pellet 48 and/or 48′ preferably has a size ranging from as little as 0.25 mm to as much as 10 mm thereby varying in length, width and/or diameter between pellets or granules having a length, width and/or diameter of between 0.25 mm and 10 mm. In a preferred extruded oil sorbent pellet embodiment, each extruded pellet 48 and/or 48′ preferably has a size no greater than about 6 mm thereby having a maximum extruded pellet length, width and/or diameter of no greater than about 6 mm.

Each extruded oil sorbent pellet 48 and/or 48′ preferably has a bulk density no greater than 40 pounds per cubic foot, and more preferably has a bulk density no greater than about 35 pounds per cubic foot (±5 pounds per cubic foot). In a preferred extruded oil sorbent pellet embodiment, each pellet 48 and/or 48′ is extruded from a sorghum admixture, in accordance with one or more of the sorghum admixtures disclosed elsewhere herein, and has a bulk density of between 20 pounds per cubic foot and 35 pounds per cubic foot. In another preferred extruded oil sorbent pellet embodiment, each pellet 48 and/or 48′ is extruded from a sorghum admixture, in accordance with one or more of the sorghum admixtures disclosed elsewhere herein, and has a bulk density of between 25 pounds per cubic foot and 30 pounds per cubic foot.

As previously discussed, a granular sorbent 42 in accordance with the present invention preferably is a granular oil sorbent 46 composed of at least a plurality of pairs, i.e. at least three, of oil sorbent granules 44 which are each preferably extruded oil sorbent granules 44 in that each granule 44 is formed of or from a pellet 48 or 48′ extruded by an extruder, preferably a single screw extruder, using any one or more of the starch-containing admixtures disclosed elsewhere herein and operating at or under any one or more of the extruder operating parameters and/or extrusion conditions also disclosed elsewhere herein. If desired, the granule oil sorbent 46 can be composed of one or more oil sorbent granules 44 each of which are formed of an extruded oil sorbent pellet 48 and/or 48′ used in their substantially as extruded condition without any post-extrusion treatment, processing or coating being done to each such uncoated pellet 48 and/or 48′. If desired, one or more oil sorbent granules 44 can be each formed of an extruded oil sorbent pellet 48 and/or 48′ which is treated, coated or otherwise processed following pellet extrusion.

In a preferred embodiment, one or more of the oil sorbent granules 44 of one preferred granular sorbent 40 are each formed of an extruded oil sorbent pellet 48 and/or 48′ coated with an another type of adsorbent material upon or after pellet extrusion that preferably substantially completely encapsulates each pellet 48 and/or 48′ in forming such a coated sorbent pellet granule 44. In one such preferred coated sorbent pellet embodiment, each such coated sorbent pellet granule 44 is formed of an extruded oil sorbent pellet 48 and/or 48′ which is substantially completely covered with a smectite, preferably a clay, and more preferably a bentonite, such as sodium bentonite, potassium bentonite or another type of bentonite. Where coated with such an adsorbent material, the adsorbent smectite, e.g., bentonite, preferably is applied in powder or small particulate form producing an outer shell that substantially completely encapsulates each sorbent granule 44 formed thereof.

In another preferred embodiment, one or more of the oil sorbent granules 44 of another preferred granular sorbent 40 are each formed of an extruded oil sorbent pellet 48 and/or 48′ that is treated after extrusion with a material, preferably in powder, particulate, granular or solution form, which either enhances adsorption and/or facilitates remediation including during and after sorbent application and use. In one such preferred embodiment, each such treated sorbent pellet granule 44 is treated with a powder, particulates, granules or a solution containing one or more strains of bacteria which digest petroleum-based oil and other petroleum-based liquids and/or waste. Where oil sorbent pellets 48 and/or 48-are treated with such powder, particulates, granules or a solution containing one or more strains of oil-breakdown facilitating bacteria to form such a treated sorbent pellet granule 44, starch in each pellet 48 and/or 48′ advantageously provides food for the bacteria during granular absorbent storage as well as during oil sorbent use.

In one preferred embodiment and method of use, oil digesting bacteria in such treated sorbent pellet granules 44 preferably are activated when the granules 44 are wetted during sorbent use. In one such preferred embodiment and method of use, wetting of sorbent pellet granules 44 containing such oil digesting bacteria with an aqueous liquid, e.g. water or a water containing liquid, activates the bacteria causing the bacteria to begin digesting oil and other petroleum liquids or waste in contact therewith.

Prior to such treatment, coating or other post-extrusion processing, each extruded oil sorbent pellet 48 and/or 48′ has a porous outer surface 54 with at least one, preferably at least a plurality, more preferably at least a plurality of pairs, i.e., at least three, pores 52 formed in the outer granule surface 54 but also has at least one pore 56, preferably at least a plurality of pores 52, in fluid-flow communication, preferably liquid-flow communication, with one or more of the internal voids or pockets 60 within the pellet 48 and/or 48′ from which oil sorbent granule 40 is formed. Granular oil sorbent 46 of the present invention preferably is composed of at least a plurality of pairs, i.e., at least three, of such porous and void-filled extruded oil sorbent granules 40 per cubic centimeter of volume of the granular oil sorbent 46 with the extruded oil sorbent pellets 48 and/or 48′ from which the oil sorbent granules 40 are formed being able to sorb, e.g. adsorb, at least 0.80 grams of oil, preferably at least 0.90 grams of oil, and more preferably at least 0.95 grams of oil per gram of extruded sorbent granules 40.

In a preferred extruded oil sorbent granule embodiment, each gram of extruded oil sorbent pellets 48 and/or 48′ (adsorption tested in their uncoated or as extruded form) of the present invention from which the oil sorbent granules 44 are formed is able to sorb via adsorption and/or absorption at least 0.80 grams of an oil having a viscosity no greater than 200 centipoises (Cp) at an oil temperature of at least 59 degrees Fahrenheit (e.g. at least 15 degrees Celsius) and which preferably possesses the same adsorption capacity at room temperature (i.e., between 20° C. and 25° C. or between 68° F. and 77° F.). In one such preferred extruded oil sorbent granule embodiment, each gram of the extruded oil sorbent pellets 48 and/or 48′ is able to sorb via adsorption and/or absorption at least 0.85 grams of such an oil having a viscosity no greater than 200 centipoises (Cp) at an oil temperature of at least 65 degrees Fahrenheit (e.g. at least 18 degrees Celsius) and which preferably possesses the same adsorption capacity at room temperature. In another such preferred extruded oil sorbent granule embodiment, each gram of the filled extruded oil sorbent granules 40 is able to sorb via adsorption and/or absorption at least 0.90 grams of an oil having a viscosity no higher than 200 centipoises (Cp) at an oil temperature of at least 59 degrees Fahrenheit (e.g. at least 15 degrees Celsius) and which preferably possesses the same adsorption capacity at room temperature. In a further such preferred extruded oil sorbent granule embodiment, each gram of the filled extruded oil sorbent granules 40 is able to sorb via adsorption and/or absorption at least 0.95 grams of an oil having a viscosity no higher than 200 centipoises (Cp) at an oil temperature of at least 59 degrees Fahrenheit (e.g. at least 15 degrees Celsius) and which preferably possesses the same adsorption capacity at room temperature. Each of the aforementioned extruded oil sorbent pellets 48 and/or 48′ preferably were extruded from a sorghum admixture, preferably extruded from one or more of the sorghum containing or sorghum based admixtures disclosed elsewhere herein using any one or more of the extruder operating parameters and/or extrusion conditions disclosed elsewhere herein.

In a preferred extruded oil sorbent granule embodiment, each gram of extruded oil sorbent pellets 48 and/or 48′ (adsorption tested in their uncoated or as extruded form) of the present invention used as or in forming oil sorbent granules 44 is able to adsorb at least 0.85 grams of an oil having a viscosity no larger than 200 centipoises (Cp) at a room temperature of between 68 degrees Fahrenheit and 77 degrees Fahrenheit (e.g., between 20-25 Celsius) when adsorption tested under ASTM F726-06. In another preferred extruded oil sorbent granule embodiment, each gram of extruded oil sorbent pellets 48 and/or 48′ of the present invention used as or in making oil sorbent granules 40 is able to adsorb at least 0.90 grams of an oil having a viscosity no larger than 200 centipoises (Cp) at a room temperature of between 68 degrees Fahrenheit and 77 degrees Fahrenheit (e.g., between 20-25 Celsius) when adsorption tested under ASTM F726-06. In still another preferred extruded oil sorbent granule embodiment, each gram of extruded oil sorbent pellets 48 and/or 48′ is able to adsorb at least 0.95 grams of an oil having a viscosity no larger than 200 centipoises (Cp) at a room temperature of between 68 degrees Fahrenheit and 77 degrees Fahrenheit (e.g., between 20-25 Celsius) when adsorption tested under ASTM F726-06. The aforementioned extruded oil sorbent pellets 48 and/or 48′ oil adsorption tested under ASTM F726-06 preferably were extruded from a sorghum admixture, preferably extruded from one or more of the sorghum containing or sorghum based admixtures disclosed elsewhere herein using any one or more of the extruder operating parameters and conditions also disclosed elsewhere herein.

In one preferred extruded oil sorbent granule embodiment, each gram of extruded oil sorbent pellets 48 and/or 48′ (adsorption tested in their uncoated or as extruded form) of the present invention used as or in forming oil sorbent granules 44 is able to adsorb at least 0.91 grams (at least 0.91 grams/gram oil adsorption), preferably at least 0.94 grams (at least 0.94 grams/gram oil adsorption), and more preferably at least 0.98 grams (at least 0.98 grams/gram oil adsorption) of a mineral oil having a viscosity no greater than 50 centipoises (Cp) at room temperature of between 68 degrees Fahrenheit and 77 degrees Fahrenheit (e.g., between 20-25 Celsius) when adsorption tested under ASTM F726-06 as modified as discussed below. In performing such adsorption in accordance with ASTM F726-06 a small screen was used in place of the basket specified in ASTM F726-06 that is controllably, i.e., slowly, immersed into the particular oil being adsorbed or tested. To account for use of such a screen in place of the basket specified in ASTM F726-06, blank adsorption test runs were performed using only the screen to obtain a combined empty screen adsorption offset weight that was then subtracted from each one of the adsorption test runs used in performing such adsorption testing. The aforementioned extruded oil sorbent pellets 48 and/or 48′ oil adsorption tested under ASTM F726-06 preferably were extruded from a sorghum admixture, preferably extruded from one or more of the sorghum containing or sorghum based admixtures disclosed elsewhere herein using any one or more of the extruder operating parameters and conditions also disclosed elsewhere herein.

In another preferred extruded oil sorbent granule embodiment, each gram of extruded oil sorbent pellets 48 and/or 48′ (adsorption tested in their uncoated or as extruded form) of the present invention used as or in forming oil sorbent granules 44 is able to adsorb at least 1.00 grams (at least 1.00 grams/gram oil adsorption), preferably at least 1.01 grams (at least 1.01 grams/gram oil adsorption), and more preferably at least 1.03 grams (at least 1.03 grams/gram oil adsorption) of a conventional 10W-30 conventional motor oil having a viscosity no greater than 70 centipoises (Cp) at a temperature of 104 degrees Fahrenheit (40 degrees Celsius) when the 10W-30 oil was adsorption tested under ASTM F726-06 (modified) while the 10W-30 oil was at room temperature. In performing such adsorption in accordance with ASTM F726-06 a small screen was used in place of the basket specified in ASTM F726-06 that is controllably, i.e., slowly, immersed into the particular oil being adsorbed or tested. To account for use of such a screen in place of the basket specified in ASTM F726-06, blank adsorption test runs were performed using only the screen to obtain a combined empty screen adsorption offset weight that was then subtracted from each one of the adsorption test runs used in performing such adsorption testing. The aforementioned extruded oil sorbent pellets 48 and/or 48′ oil adsorption tested under ASTM F726-06 preferably were extruded from a sorghum admixture, preferably extruded from one or more of the sorghum containing or sorghum based admixtures disclosed elsewhere herein using any one or more of the extruder operating parameters and conditions also disclosed elsewhere herein.

In one preferred method of making extruded oil sorbent pellets 48 and/or 48′ in accordance with the present invention, such a starch-containing mixture is extruded under extruder operating parameters and conditions in accordance with any one or more of those disclosed herein sufficient to discharge starch-containing pellets 48 and/or 48′ from the extruder each having an outer pellet surface 50 with at least one oil-adsorption increasing pore 52 formed therein and which preferably is a porous outer pellet surface 54 with at least a plurality, preferably at least a plurality of pairs, i.e., at least three, of the pores 52 formed therein producing extruded oil sorbent pellets 48 and/or 48′ and/or oil sorbent granules 44 formed thereof or therefrom of the present invention having an adsorption capacity of at least 0.85 grams of oil per gram of oil sorbent extrudate, i.e., extruded pellets 48 and/or 48′, when oil adsorbent tested in their uncoated as-extruded form in accordance with ASTM F726-06. In another preferred method of making extruded oil sorbent pellets 48 and/or 48′ in accordance with the present invention, such a starch-containing mixture is extruded under extruder operating parameters and conditions in accordance with any one or more of those disclosed herein sufficient to discharge starch-containing pellets 48 and/or 48′ from the extruder each having an outer pellet surface 50 with at least one oil-adsorption increasing pore 52 formed therein and which preferably is a porous outer pellet surface 54 with at least a plurality, preferably at least a plurality of pairs, i.e., at least three, of the pores 52 formed therein producing extruded oil sorbent pellets 48 and/or 48′ and/or oil sorbent granules 44 formed thereof or therefrom of the present invention having an adsorption capacity of at least 0.90 grams of oil per gram of the extruded pellets 48 when oil adsorbent tested in accordance with ASTM F726-06. In a further preferred method of making extruded oil sorbent pellets 48 and/or 48′ in accordance with the present invention, such a starch-containing mixture is extruded under extruder operating parameters and conditions in accordance with any one or more of those disclosed herein sufficient to discharge starch-containing pellets 48 and/or 48′ from the extruder each having an outer pellet surface 50 with at least one oil-adsorption increasing pore 52 formed therein and which preferably is a porous outer pellet surface 54 with at least a plurality, preferably at least a plurality of pairs, i.e., at least three, of the pores 52 formed therein producing extruded oil sorbent pellets 48 and/or 48′ and/or oil sorbent granules 44 formed of or therefrom of the present invention having an adsorption capacity of at least 0.95 grams of oil per gram of the extruded pellets 48 and/or 48′ when oil adsorbent tested in accordance with ASTM F726-06. The aforementioned extruded oil sorbent pellets 48 and/or 48′ oil adsorption tested under ASTM F726-06 preferably were extruded from a sorghum admixture, preferably extruded from one or more of the sorghum containing or sorghum based admixtures disclosed elsewhere herein using any one or more of the extruder operating parameters and conditions also disclosed elsewhere herein.

In a second preferred method of making extruded oil sorbent pellets 48 in accordance with the present invention, the starch-containing mixture is extruded under such aforementioned extruder operating parameters and conditions in accordance with any one or more of those disclosed herein sufficient to form extruded starch-containing oil sorbent pellets 48 and/or 48′ each having an outer pellet surface 50 with at least one oil-adsorption increasing pore 52 formed therein and which preferably is a porous outer pellet surface 54 with at least a plurality, preferably at least a plurality of pairs, i.e., at least three, of the pores 52 formed therein and also each having a void-filled interior 56 composed of at least one and preferably at least a plurality of oil-adsorption capacity increasing void or pockets 58, formed within each pellet 48 and/or 48′ during or by extrusion thereby producing extruded oil sorbent pellets 48 and/or 48′ and/or oil sorbent granules 44 formed thereof or therefrom of the present invention having an adsorption capacity of at least 0.85 grams of oil per gram of the extruded pellets 48 and/or 48′ when tested in accordance with ASTM F726-06. In another such preferred method of making extruded oil sorbent pellets 48 and/or 48′ in accordance with the present invention, the starch-containing mixture is extruded under such aforementioned extruder operating parameters and conditions sufficient to form extruded starch-containing oil sorbent pellets 48 and/or 48′ each having an outer pellet surface 50 with at least one oil-adsorption increasing pore 52 formed therein and which preferably is a porous outer pellet surface 54 with at least a plurality, preferably at least a plurality of pairs, i.e., at least three, of the pores 52 formed therein and also each having a void-filled interior 56 composed of at least one and preferably at least a plurality of oil-adsorption capacity increasing void or pockets 58, formed within each pellet 48 and/or 48′ during or by extrusion thereby producing extruded oil sorbent pellets 48 and/or 48′ and/or oil sorbent granules 44 formed of or therefrom of the present invention having an adsorption capacity of at least 0.90 grams of oil per gram of the extruded pellets 48 and/or 48′ when tested in accordance with ASTM F726-06. In a further such preferred method of making extruded oil sorbent pellets 48 in accordance with the present invention, the starch-containing mixture is extruded under extruder operating parameters and conditions in accordance with any one or more of those disclosed above sufficient to form extruded starch-containing oil sorbent pellets 48 and/or 48′ each having an outer pellet surface 50 with at least one oil-adsorption increasing pore 52 formed therein and which preferably is a porous outer pellet surface 54 with at least a plurality, preferably at least a plurality of pairs, i.e., at least three, of the pores 52 formed therein and also each having a void-filled interior 56 composed of at least one and preferably at least a plurality of oil-adsorption capacity increasing void or pockets 58, formed within each pellet 48 and/or 48′ during or by extrusion thereby producing extruded oil sorbent pellets 48 and/or 48′ of the present invention having an adsorption capacity of at least 0.95 grams of oil per gram of the extruded pellets 48 when tested in accordance with ASTM F726-06. The aforementioned extruded oil sorbent pellets 48 and/or 48′ oil adsorption tested under ASTM F726-06 preferably were extruded from a sorghum admixture, preferably extruded from one or more of the sorghum containing or sorghum based admixtures disclosed elsewhere herein using any one or more of the extruder operating parameters and conditions also disclosed elsewhere herein.

In a third preferred method of making extruded oil sorbent pellets 48 and/or 48′ in accordance with the present invention, the starch-containing mixture is extruded under extruder operating parameters and conditions in accordance with any one or more of those disclosed elsewhere herein sufficient to form extruded starch-containing oil sorbent pellets 48 and/or 48′ which have at least five percent (5%) liquid soluble content by pellet weight which can dissolve during sorbent use when wetted with a liquid producing oil sorbent pellets 48 and/or 48′ of the present invention with an increased and/or enhanced oil sorption that have an adsorption capacity of at least 0.85 grams of oil per gram of oil sorbent pellets when tested in accordance with ASTM F726-06. In one such method of making extruded oil sorbent pellets 48 and/or 48′ in accordance with the present invention, the starch-containing mixture is extruded under extruder operating parameters and conditions in accordance with any one or more of those disclosed above sufficient to form extruded starch-containing oil sorbent pellets 48 and/or 48′ that each also have at least five percent (5%) water soluble content by pellet weight which can and preferably does at least partially or completely dissolve or solubilize when wetted with an aqueous liquid, e.g., water, during and/or after adsorbent use producing sorbent pellets 48 and/or 48′ having an adsorption capacity of at least 0.90 grams of oil per gram of oil sorbent extrudate when tested in accordance with ASTM F726-06. In another such method of making extruded oil sorbent pellets 48 and/or 48′ in accordance with the present invention, the starch-containing mixture is extruded under extruder operating parameters and conditions in accordance with any one or more of those disclosed elsewhere herein sufficient to form extruded starch-containing oil sorbent pellets 48 and/or 48′ that each also have at least five percent (5%) water soluble content by pellet weight formed of starch in the mixture modified by or during extrusion which at least partially dissolves or solubilizes when wetted with an aqueous liquid, e.g., water, during and/or after adsorbent use producing sorbent pellets 48 and/or 48′ having an adsorption capacity of at least 0.90 grams of oil per gram of oil sorbent extrudate when tested in accordance with ASTM F726-06. In still another such method of making extruded oil sorbent pellets 48 and/or 48′ in accordance with the present invention, the starch-containing mixture is extruded under extruder operating parameters and conditions in accordance with any one or more of those disclosed herein sufficient to form extruded starch-containing oil sorbent pellets 48 and/or 48′ that each have at least ten percent (10%) water soluble content by pellet weight formed of starch in the mixture modified by or during extrusion which at least partially dissolves or solubilizes when wetted with an aqueous liquid, e.g., water, during and/or after adsorbent use producing sorbent pellets 48 and/or 48′ having an adsorption capacity of at least 0.92 grams of oil per gram of oil sorbent extrudate when tested in accordance with ASTM F726-06. In a further such method of making extruded oil sorbent pellets 48 and/or 48′ in accordance with the present invention, the starch-containing mixture is extruded under extruder operating parameters and conditions in accordance with any one or more disclosed above sufficient to form extruded starch-containing oil sorbent pellets 48 and/or 48′ that have at least fifteen percent (15%) water soluble content by pellet weight formed of starch in the mixture modified by or during extrusion which at least partially dissolves or solubilizes during adsorbent use when wetted with an aqueous liquid, e.g., water, producing sorbent pellets 48 and/or 48′ having an adsorption capacity of at least 0.95 grams of oil per gram of oil sorbent extrudate when tested in accordance with ASTM F726-06. In a still further such method of making extruded oil sorbent pellets 48 and/or 48′ in accordance with the present invention, the starch-containing mixture is extruded under extruder operating parameters and conditions in accordance with any one or more of those disclosed herein sufficient to form extruded starch-containing oil sorbent pellets 48 and/or 48′ that each have at least twenty percent (20%) water soluble content by pellet weight formed of starch in the mixture modified by or during extrusion which at least partially dissolves or solubilizes when wetted with an aqueous liquid, e.g., water, during and/or after adsorbent use producing sorbent pellets 48 and/or 48′ having an adsorption capacity of at least 0.98 grams of oil per gram of oil sorbent extrudate when tested in accordance with ASTM F726-06. The aforementioned extruded oil sorbent pellets 48 and/or 48′ oil adsorption tested under ASTM F726-06 preferably were extruded from a sorghum admixture, preferably extruded from one or more of the sorghum containing or sorghum based admixtures disclosed elsewhere herein using any one or more of the extruder operating parameters and conditions also disclosed elsewhere herein.

In a fourth preferred method of making extruded oil sorbent pellets 48 and/or 48′ in accordance with the present invention, the starch-containing mixture is extruded under extruder operating parameters and conditions in accordance with any one or more of those disclosed herein sufficient to form extruded starch-containing oil sorbent pellets 48 that are each porous and which also have at least five percent (5%) liquid soluble content by pellet weight which can at least partially dissolve or solubilize when wetted with a liquid during sorbent use producing oil sorbent pellets 48 and/or 48′ of the present invention with an increased and/or enhanced oil sorption that have an adsorption capacity of at least 0.85 grams of oil per gram of oil sorbent pellets 48 and/or 48′ when oil adsorbent tested in their uncoated as-extruded form in accordance with ASTM F726-06. In one such method of making extruded oil sorbent pellets 48 and/or 48′ in accordance with the present invention, the starch-containing mixture is extruded under such aforementioned extruder operating parameters and conditions sufficient to form extruded starch-containing oil sorbent pellets 48 and/or 48′ that are each porous and which also have at least five percent (5%) water soluble content by pellet weight formed of starch in the mixture modified by or during extrusion which at least partially dissolves or solubilizes when wetted with an aqueous liquid, e.g., water, during or after adsorbent use producing sorbent pellets 48 and/or 48′ having an adsorption capacity of at least 0.90 grams of oil per gram of oil sorbent extrudate when tested in accordance with ASTM F726-06. In another such method of making extruded oil sorbent pellets 48 and/or 48′ in accordance with the present invention, the starch-containing mixture is extruded under extruder operating parameters and conditions in accordance with any one or more of those disclosed above sufficient to form extruded starch-containing oil sorbent pellets 48 and/or 48′ that are each porous and which also have at least seven percent (7%) water soluble content by pellet weight formed of starch in the mixture modified by or during extrusion which at least partially dissolves or solubilizes when wetted with an aqueous liquid, e.g., water, during or after adsorbent use producing sorbent pellets 48 and/or 48′ having an adsorption capacity of at least 0.92 grams of oil per gram of oil sorbent extrudate when tested in accordance with ASTM F726-06. In a further such method of making extruded oil sorbent pellets 48 and/or 48′ in accordance with the present invention, the starch-containing mixture is extruded under such aforementioned extruder operating parameters and conditions sufficient to form extruded starch-containing oil sorbent pellets 48 and/or 48′ that are each porous and which also have at least ten percent (10%) water soluble content by pellet weight formed of starch in the mixture modified by or during extrusion which at least partially dissolves or solubilizes when wetted with an aqueous liquid, e.g., water, during and/or after adsorbent use producing sorbent pellets 48 and/or 48′ having an adsorption capacity of at least 0.95 grams of oil per gram of oil sorbent extrudate when tested in accordance with ASTM F726-06. In a further such method of making extruded oil sorbent pellets 48 and/or 48′ in accordance with the present invention, the starch-containing mixture is extruded under extruder operating parameters and conditions in accordance with any one or more disclosed herein sufficient to form extruded starch-containing oil sorbent pellets 48 and/or 48′ that are each porous and which also have at least fifteen percent (15%) water soluble content by pellet weight formed of starch in the mixture modified by or during extrusion which at least partially dissolves and/or solubilizes when wetted with an aqueous liquid, e.g., water, during or after adsorbent use producing sorbent pellets 48 and/or 48′ having an adsorption capacity of at least 0.98 grams of oil per gram of oil sorbent extrudate when tested in accordance with ASTM F726-06. The aforementioned extruded oil sorbent pellets 48 and/or 48′ oil adsorption tested under ASTM F726-06 preferably were extruded from a sorghum admixture, preferably extruded from one or more of the sorghum containing or sorghum based admixtures disclosed elsewhere herein using any one or more of the extruder operating parameters and conditions also disclosed elsewhere herein.

In a fifth preferred method of making extruded oil sorbent pellets 48 and/or 48′ in accordance with the present invention, the starch-containing mixture is extruded under extruder operating parameters and conditions in accordance with any of those disclosed above sufficient to form extruded starch-containing oil sorbent pellets 48 and/or 48′ that are each porous and void filled and which each also have at least five percent (5%) liquid soluble content by pellet weight can and preferably does at least partially dissolve or at least partially solubilize during and/or after oil sorbent use when wetted with a liquid producing oil sorbent pellets 48 and/or 48′ of the present invention with an increased and/or enhanced oil sorption having an adsorption capacity of at least 0.85 grams of oil per gram of oil sorbent pellets 48 when tested in accordance with ASTM F726-06. In one such method of making extruded oil sorbent pellets 48 and/or 48′ in accordance with the present invention, the starch-containing mixture is extruded under extruder operating parameters and conditions in accordance with any one or more of those disclosed above sufficient to form extruded starch-containing oil sorbent pellets 48 and/or 48′ that are each porous and void-filled and which each also have at least five percent (5%) water soluble content by pellet weight which at least partially dissolves or at least partially solubilizes when wetted with an aqueous liquid, e.g., water or a water-based liquid, during or after sorbent use producing sorbent pellets 48 and/or 48′ having an adsorption capacity of at least 0.90 grams of oil per gram of oil sorbent extrudate when tested in accordance with ASTM F726-06. In another such method of making extruded oil sorbent pellets 48 and/or 48′ in accordance with the present invention, the starch-containing mixture is extruded under one or more such aforementioned extruder operating parameters and conditions sufficient to form extruded starch-containing oil sorbent pellets 48 and/or 48′ that are each porous and void-filled and which each also have at least five percent (5%) water soluble content by pellet weight formed of starch in the mixture modified by or during extrusion which at least partially dissolves or solubilizes when wetted with an aqueous liquid, e.g., water or a liquid containing water, during and/or after oil sorbent use producing sorbent pellets 48 and/or 48′ having an adsorption capacity of at least 0.90 grams of oil per gram of oil sorbent extrudate when tested in accordance with ASTM F726-06. In yet another such method of making extruded oil sorbent pellets 48 and/or 48′ in accordance with the present invention, the starch-containing mixture is extruded under extruder operating parameters and conditions in accordance with any one or more disclosed herein sufficient to form extruded starch-containing oil sorbent pellets 48 and/or 48′ that are each porous and void-filled and which each also have at least ten percent (10%) water soluble content by pellet weight formed of starch in the mixture modified by or during extrusion which at least partially dissolves or solubilizes when wetted with an aqueous liquid, e.g., water or a liquid containing water, during or after oil sorbent use producing sorbent pellets 48 and/or 48′ having an adsorption capacity of at least 0.95 grams of oil per gram of oil sorbent extrudate when tested in accordance with ASTM F726-06. In a further such method of making extruded oil sorbent pellets 48 and/or 48′ and/or oil sorbent granules 44 formed of or therefrom in accordance with the present invention, the starch-containing mixture is extruded under any one or more of the aforementioned extruder operating parameters and conditions sufficient to form extruded starch-containing oil sorbent pellets 48 and/or 48′ that are each porous and void-filled and which each also have at least fifteen percent (15%) water soluble content by pellet weight formed of starch in the mixture modified by or during extrusion which at least partially dissolves or solubilizes when wetted during and/or following oil adsorbent use with an aqueous liquid, e.g., water or a liquid containing water, producing sorbent pellets 48 and/or 48′ having an adsorption capacity of at least 0.85 grams of oil per gram of oil sorbent extrudate when tested in accordance with ASTM F726-06. In still another such method of making extruded oil sorbent pellets 48 and/or 48′ and/or oil sorbent granules 44 formed of or therefrom in accordance with the present invention, the starch-containing mixture is extruded under any one or more of the aforementioned extruder operating parameters and conditions sufficient to form extruded starch-containing oil sorbent pellets 48 and/or 48′ that are each porous and void-filled and which each also have at least fifteen percent (15%) water soluble content by pellet weight formed of starch in the mixture modified by or during extrusion which at least partially dissolves or solubilizes during and/or after oil adsorbent use when wetted with an aqueous liquid, e.g., water or a liquid containing water, producing sorbent pellets 48 and/or 48′ having an adsorption capacity of at least 0.90 grams of oil per gram of oil sorbent extrudate when tested in accordance with ASTM F726-06. The aforementioned extruded oil sorbent pellets 48 and/or 48′ oil adsorption tested under ASTM F726-06 preferably were extruded from a sorghum admixture, preferably extruded from one or more of the sorghum containing or sorghum based admixtures disclosed elsewhere herein using any one or more of the extruder operating parameters and conditions also disclosed elsewhere herein.

In a sixth preferred method of making extruded oil sorbent pellets 48 and/or 48′ in accordance with the present invention, the starch-containing mixture is extruded under extruder operating parameters and conditions in accordance with any one or more of those described herein sufficient to form extruded starch-containing oil sorbent pellets 48 and/or 48′ that have a sufficient amount of liquid soluble binder to agglutinate when wetted with a liquid, including when wetted with such a liquid during or after oil adsorption, with such extruded oil sorbent pellets 48 and/or 48′ of the present invention having an adsorption capacity of at least 0.85 grams of oil per gram of the extruded pellets 48 when tested in their uncoated as-extruded form in accordance with ASTM F726-06. In one such preferred method of making extruded oil sorbent pellets 48 and/or 48′ in accordance with the present invention, the starch-containing mixture is extruded under any one or more of the aforementioned extruder operating parameters and conditions sufficient to form extruded starch-containing oil sorbent pellets 48 and/or 48′ that have a sufficient amount of water soluble binder to at least agglutinate and/or clump when wetted with an aqueous liquid, e.g., water or water-based liquid, including when wetted with such an aqueous liquid during or after oil adsorption, with such extruded oil sorbent pellets 48 and/or 48′ of the present invention having an adsorption capacity of at least 0.85 grams of oil per gram of the extruded pellets 48 and/or 48′ when tested in accordance with ASTM F726-06. In another such preferred method of making extruded oil sorbent pellets 48 in accordance with the present invention, the starch-containing mixture is extruded under extruder operating parameters and conditions in accordance with any one or more of those disclosed herein sufficient to form extruded starch-containing oil sorbent pellets 48 and/or 48′ that have at least five percent (5%) water soluble binder enabling pellets 48 and/or 48′ to at least agglutinate and/or clump when wetted with an aqueous liquid, e.g., water or a liquid that contains water, including when wetted with such an aqueous liquid during or after oil adsorption, with such extruded oil sorbent pellets 48 and/or 48′ of the present invention having an adsorption capacity of at least 0.85 grams of oil per gram of the extruded pellets 48 when tested in accordance with ASTM F726-06. In still another such preferred method of making extruded oil sorbent pellets 48 and/or 48′ in accordance with the present invention, the starch-containing mixture is extruded under any one or more of the aforementioned extruder operating parameters and conditions sufficient to form extruded starch-containing oil sorbent pellets 48 and/or 48′ that have at least seven percent (7%) water soluble binder enabling pellets 48 and/or 48′ to at least agglutinate and/or clump when wetted with an aqueous liquid, e.g., water or a liquid that contains water, including when wetted with such an aqueous liquid during or after oil sorbent use, with such extruded oil sorbent pellets 48 and/or 48′ of the present invention having an adsorption capacity of at least 0.90 grams of oil per gram of the extruded pellets 48 and/or when tested in accordance with ASTM F726-06. In a further such preferred method of making extruded oil sorbent pellets 48 and/or 48′ in accordance with the present invention, the starch-containing mixture is extruded under extruder operating parameters and conditions in accordance with any of those disclosed above sufficient to form extruded starch-containing oil sorbent pellets 48 and/or 48′ that have at least ten percent (10%) water soluble binder enabling pellets 48 and/or 48′ to at least agglutinate and/or preferably form clumps when wetted with an aqueous liquid, e.g., water or a liquid that contains water, including when wetted with such an aqueous liquid during or after oil adsorption, with such extruded oil sorbent pellets 48 and/or 48′ of the present invention having an adsorption capacity of at least 0.92 grams of oil per gram of the extruded pellets 48 and/or 48′ when tested in accordance with ASTM F726-06. In a still further such preferred method of making extruded oil sorbent pellets 48 and/or 48′ in accordance with the present invention, the starch-containing mixture is extruded under any one or more such aforementioned extruder operating parameters and conditions sufficient to form extruded starch-containing oil sorbent pellets 48 and/or 48′ that have at least twelve and one-half percent (12.5%) water soluble binder enabling pellets 48 to at least agglutinate and preferably clump when wetted with an aqueous liquid, e.g., water or a liquid that contains water, including when wetted with such an aqueous liquid during or after picking up oil, with such extruded oil sorbent pellets 48 and/or 48′ of the present invention having an adsorption capacity of at least 0.95 grams of oil per gram of the extruded pellets 48 and/or 48′ when tested in accordance with ASTM F726-06. In yet another such preferred method of making extruded oil sorbent pellets 48 and/or 48′ in accordance with the present invention, the starch-containing mixture is extruded under extruder operating parameters and conditions in accordance with any one or more of those disclose herein sufficient to form extruded starch-containing oil sorbent pellets 48 and/or 48′ that have at least fifteen percent (15%) water soluble binder enabling pellets 48 and/or 48′ to at least agglutinate and preferably clump when wetted with an aqueous liquid, e.g., water or a liquid that contains water, including when wetted with such an aqueous liquid during or after sorbent, with such extruded oil sorbent pellets 48 and/or 48′ of the present invention having an adsorption capacity of at least 0.98 grams of oil per gram of the extruded pellets 48 and/or 48′ when tested in accordance with ASTM F726-06 The aforementioned extruded oil sorbent pellets 48 and/or 48′ oil adsorption tested under ASTM F726-06 preferably were extruded from a sorghum admixture, preferably extruded from one or more of the sorghum containing or sorghum based admixtures disclosed elsewhere herein using any one or more of the extruder operating parameters and conditions also disclosed elsewhere herein.

In a seventh preferred method of making extruded oil sorbent pellets 48 in accordance with the present invention, the starch-containing mixture is extruded under extruder operating parameters and conditions in accordance with any of those disclosed above sufficient to form extruded starch-containing oil sorbent pellets 48 and/or 48′ that are each porous and which each also have an amount of liquid soluble binder sufficient to at least cause agglutination of the sorbent pellets 48 and/or 48′ and/or granules 44 formed of or therefrom when wetted with or by a liquid during or after adsorbent use in adsorbing a liquid with such extruded oil sorbent pellets 48 and/or 48′ of the present invention preferably also having an adsorption capacity of at least 0.85 grams of oil per gram of oil sorbent pellets 48 and/or 48′ when tested in their uncoated as-extruded form in accordance with ASTM F726-06. In another such preferred method of making extruded oil sorbent pellets 48 and/or 48′ in accordance with the present invention, the starch-containing mixture is extruded under extruder operating parameters and conditions in accordance with any one or more of those disclosed elsewhere herein sufficient to form extruded starch-containing oil sorbent pellets 48 and/or 48′ that are each porous and which each also have an amount of liquid soluble binder formed of or from starch in the mixture physically and/or thermally modified by or during pellet sufficient to at least at least cause agglutination and/or clumping of the sorbent pellets 48 and/or 48′ and/or granules 44 formed of or therefrom when wetted with or by a liquid during and/or after sorbent use in adsorbing a liquid with such extruded oil sorbent pellets 48 and/or 48′ of the present invention preferably also having an adsorption capacity of at least 0.90 grams of oil per gram of oil sorbent pellets 48 and/or 48′ when tested in accordance with ASTM F726-06. The aforementioned extruded oil sorbent pellets 48 and/or 48′ oil adsorption tested under ASTM F726-06 preferably were extruded from a sorghum admixture, preferably extruded from one or more of the sorghum containing or sorghum based admixtures disclosed elsewhere herein using any one or more of the extruder operating parameters and conditions also disclosed elsewhere herein.

In an eighth such preferred method of making extruded oil sorbent pellets 48 and/or 48′ in accordance with the present invention, the starch-containing mixture is extruded under extruder operating parameters and conditions, including any of those disclosed above, sufficient to form extruded starch-containing oil sorbent pellets 48 and/or 48′ that are each porous and which each also have an amount of water soluble binder formed of or from starch in the mixture physically and/or thermally modified by or during pellet sufficient to cause agglutination and/or clumping of the sorbent pellets 48 and/or 48′ and/or granules 44 formed of or therefrom when wetted with or by an aqueous liquid during or after adsorbent use in adsorbing a liquid with such extruded oil sorbent pellets 48 and/or 48′ of the present invention preferably also having an adsorption capacity of at least 0.85 grams of oil per gram of oil sorbent pellets 48 and/or 48′ when tested in their uncoated as-extruded form in accordance with ASTM F726-06. In a further such preferred method of making extruded oil sorbent pellets 48 and/or 48′ in accordance with the present invention, the starch-containing mixture is extruded under such aforementioned extruder operating parameters and conditions sufficient to form extruded starch-containing oil sorbent pellets 48 and/or 48′ that are each porous and which each also have at least five percent (5%) water soluble binder by pellet weight formed of or from starch in the mixture physically and/or thermally modified by or during pellet that facilitates or causes agglutination and/or clumping of the sorbent pellets 48 and/or 48′ and/or granules 44 formed thereof or therefrom when wetted with or by an aqueous liquid during or after adsorbent use in adsorbing an oil with such extruded oil sorbent pellets 48 and/or 48′ of the present invention preferably also having an adsorption capacity of at least 0.85 grams of oil per gram of oil sorbent pellets 48 and/or 48′ when tested in accordance with ASTM F726-06. In a still further such preferred method of making extruded oil sorbent pellets 48 and/or 48′ in accordance with the present invention, the starch-containing mixture is extruded under extruder operating parameters and conditions in accordance with any of those disclosed above sufficient to form extruded starch-containing oil sorbent pellets 48 and/or 48′ that are each porous and which each also have at least seven percent (7%) water soluble binder by pellet weight formed of or from starch in the mixture physically and/or thermally modified by or during pellet that facilitates or causes agglutination and/or clumping of the sorbent pellets 48 and/or 48′ and/or granules 44 formed thereof or therefrom when wetted with or by an aqueous liquid during or after adsorbent use in adsorbing an oil with such extruded oil sorbent pellets 48 and/or 48′ of the present invention preferably also having an adsorption capacity of at least 0.90 grams of oil per gram of oil sorbent pellets 48 and/or 48′ when tested in accordance with ASTM F726-06. In yet another such preferred method of making extruded oil sorbent pellets 48 and/or 48′ in accordance with the present invention, the starch-containing mixture is extruded under such aforementioned extruder operating parameters and conditions sufficient to form extruded starch-containing oil sorbent pellets 48 and/or 48′ that are each porous and which each also have at least ten percent (10%) water soluble binder by pellet weight formed of or from starch in the mixture physically and/or thermally modified by or during pellet that facilitates or causes at least agglutination and preferably clumping of the sorbent pellets 48 and/or 48′ and/or oil sorbent granules 44 formed thereof or therefrom when wetted with or by an aqueous liquid during or after adsorbent use in adsorbing an oil with such extruded oil sorbent pellets 48 and/or 48′ of the present invention preferably also having an adsorption capacity of at least 0.92 grams of oil per gram of oil sorbent pellets 48 and/or 48′ when tested in accordance with ASTM F726-06. In still yet another such preferred method of making extruded oil sorbent pellets 48 and/or 48′ in accordance with the present invention, the starch-containing mixture is extruded under extruder operating parameters and conditions in accordance with any of those disclosed herein sufficient to form extruded starch-containing oil sorbent pellets 48 and/or 48′ that are each porous and which each also have at least twelve and one-half percent (12.5%) water soluble binder by pellet weight formed of or from starch in the mixture physically and/or thermally modified by or during pellet that facilitates or causes agglutination and preferably clumping of the sorbent pellets 48 and/or 48′ and/or oil sorbent granules 44 formed thereof or therefrom when wetted with or by an aqueous liquid during or after adsorbent use in adsorbing an oil with such extruded oil sorbent pellets 48 and/or 48′ of the present invention preferably also having an adsorption capacity of at least 0.95 grams of oil per gram of oil sorbent pellets 48 and/or 48′ when tested in accordance with ASTM F726-06. The aforementioned extruded oil sorbent pellets 48 and/or 48′ oil adsorption tested under ASTM F726-06 preferably were extruded from a sorghum admixture, preferably extruded from one or more of the sorghum containing or sorghum based admixtures disclosed elsewhere herein using any one or more of the extruder operating parameters and conditions also disclosed elsewhere herein.

In a ninth preferred method of making extruded oil sorbent pellets 48 and/or 48′ in accordance with the present invention, the starch-containing mixture is extruded under extruder operating parameters and conditions in accordance with any of those disclosed elsewhere herein sufficient to form extruded starch-containing oil sorbent pellets 48 and/or 48′ that are each porous, void-filled, and which each also have an amount of liquid soluble binder sufficient to at least cause agglutination of the sorbent pellets 48 and/or 48′ and/or oil sorbent granules 44 formed thereof or therefrom when wetted with or by a liquid during or after adsorbent use in adsorbing a liquid with such extruded oil sorbent pellets 48 and/or 48′ of the present invention preferably also having an adsorption capacity of at least 0.85 grams of oil per gram of oil sorbent pellets 48 and/or 48′ when tested in accordance with ASTM F726-06. In another such preferred method of making extruded oil sorbent pellets 48 and/or 48′ in accordance with the present invention, the starch-containing mixture is extruded under such aforementioned extruder operating parameters and conditions sufficient to form extruded starch-containing oil sorbent pellets 48 and/or 48′ that are each porous, void-filled, and which each also have an amount of liquid soluble binder formed of or from starch in the mixture physically and/or thermally modified by or during pellet sufficient to cause agglutination and/or clumping of the sorbent pellets 48 and/or 48′ and/or granules 44 when wetted with or by a liquid during or after adsorbent use in adsorbing a liquid, including oil, with such extruded oil sorbent pellets 48 and/or 48′ of the present invention preferably also having an adsorption capacity of at least 0.90 grams of oil per gram of oil sorbent pellets 48 and/or 48′ when tested in accordance with ASTM F726-06. The aforementioned extruded oil sorbent pellets 48 and/or 48′ oil adsorption tested under ASTM F726-06 preferably were extruded from a sorghum admixture, preferably extruded from one or more of the sorghum containing or sorghum based admixtures disclosed elsewhere herein.

In a tenth such preferred method of making extruded oil sorbent pellets 48 and/or 48′ in accordance with the present invention, the starch-containing mixture is extruded under any one or more of the aforementioned extruder operating parameters and conditions sufficient to form extruded starch-containing oil sorbent pellets 48 and/or 48′ that are each porous, void-filled, and which each also have an amount of water soluble binder formed of or from starch in the mixture physically and/or thermally modified by or during pellet sufficient to cause agglutination and/or clumping of the sorbent pellets 48 and/or 48′ and/or granules 44 when wetted with or by an aqueous liquid during or after adsorbent use in adsorbing a liquid, including an oil, with such extruded oil sorbent pellets 48 and/or 48′ of the present invention preferably also having an adsorption capacity of at least 0.85 grams of oil per gram of oil sorbent pellets when oil adsorbent tested in their uncoated as-extruded form in accordance with ASTM F726-06. In a further such preferred method of making extruded oil sorbent pellets 48 and/or 48′ in accordance with the present invention, the starch-containing mixture is extruded under such aforementioned extruder operating parameters and conditions sufficient to form extruded starch-containing oil sorbent pellets 48 and/or 48′ that are each porous, void-filled, and which each also have at least five percent (5%) water soluble binder by pellet weight formed of or from starch in the mixture physically and/or thermally modified by or during pellet that facilitates or causes agglutination and/or clumping of the sorbent pellets 48 and/or 48′ and/or granules 44 when wetted with or by an aqueous liquid during or after sorbent use in adsorbing an oil with such extruded oil sorbent pellets 48 and/or 48′ of the present invention preferably also having an adsorption capacity of at least 0.85 grams of oil per gram of oil sorbent pellets when tested in accordance with ASTM F726-06. In a still further such preferred method of making extruded oil sorbent pellets 48 and/or 48′ in accordance with the present invention, the starch-containing mixture is extruded under extruder operating parameters and conditions in accordance with any of those disclosed above sufficient to form extruded starch-containing oil sorbent pellets 48 and/or 48′ that are each porous, void-filled, and which each also have at least seven percent (7%) water soluble binder by pellet weight formed of or from starch in the mixture physically and/or thermally modified by or during pellet that facilitates or causes agglutination and/or clumping of the sorbent pellets 48 when wetted with or by an aqueous liquid during or after sorbent use in picking up an oil with such extruded oil sorbent pellets 48 and/or 48 and/or granules 44 formed thereof or therefrom of the present invention preferably also having an adsorption capacity of at least 0.90 grams of oil per gram of such oil sorbent extrudate when tested in accordance with ASTM F726-06. In yet another such preferred method of making extruded oil sorbent pellets 48 and/or 48′ in accordance with the present invention, the starch-containing mixture is extruded under extruder operating parameters and conditions in accordance with any of those disclosed above sufficient to form extruded starch-containing oil sorbent pellets 48 and/or 48′ that are each porous, void-filled, and which each also have at least ten percent (10%) water soluble binder by pellet weight formed of or from starch in the mixture physically and/or thermally modified by or during pellet that facilitates or causes agglutination and preferably clumping of the sorbent pellets 48 and/or 48′ and/or granules 44 when wetted with or by an aqueous liquid during or after adsorbent use in adsorbing an oil with such extruded oil sorbent pellets 48 and/or 48′ of the present invention preferably also having an adsorption capacity of at least 0.92 grams of oil per gram of such oil sorbent pellets when tested in accordance with ASTM F726-06. In still yet another such preferred method of making extruded oil sorbent pellets 48 and/or 48′ in accordance with the present invention, the starch-containing mixture is extruded under extruder operating parameters and conditions in accordance with any of those disclosed elsewhere herein sufficient to form extruded starch-containing oil sorbent pellets 48 and/or 48′ that are each porous, void-filled, and which each also have at least twelve and one-half percent (12.5%) water soluble binder by pellet weight formed of or from starch in the mixture physically and/or thermally modified by or during pellet that facilitates or causes agglutination of the sorbent pellets 48 and/or 48′ and/or granules 44 when wetted with or by an aqueous liquid during or after sorbent use in adsorbing an oil with such extruded oil sorbent pellets 48 and/or 48′ of the present invention preferably also having an adsorption capacity of at least 0.95 grams of oil per gram of oil sorbent pellets 48 and/or 48′ when tested in accordance with ASTM F726-06. The aforementioned extruded oil sorbent pellets 48 and/or 48′ oil adsorption tested under ASTM F726-06 preferably were extruded from a sorghum admixture, preferably extruded from one or more of the sorghum containing or sorghum based admixtures disclosed elsewhere herein using any one or more of the extruder operating parameters and conditions also disclosed elsewhere herein.

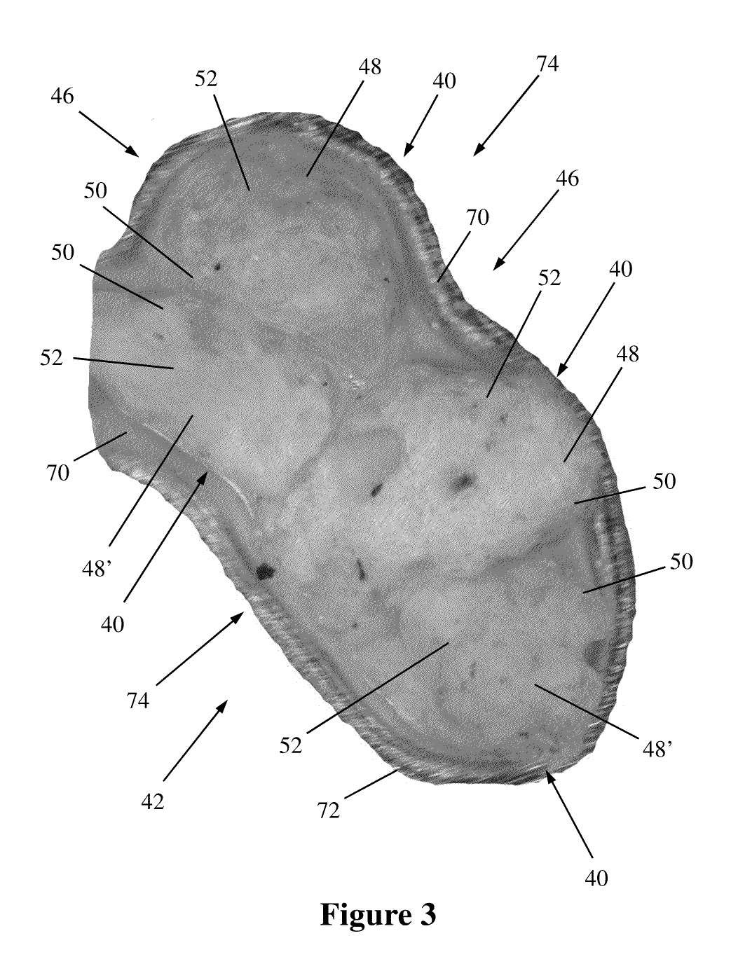

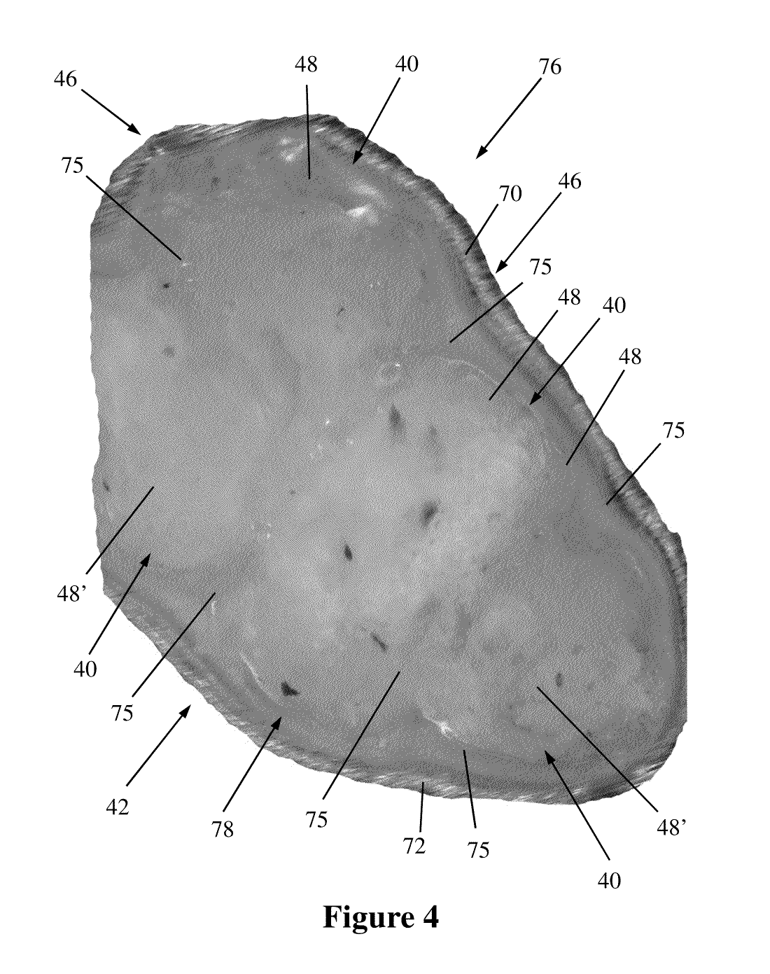

With additional reference to FIGS. 3 and 4, FIG. 3 shows oil sorbent use of a preferred embodiment of the granular sorbent 42 shown in FIG. 1 that is a granular oil sorbent 46 in accordance with the present invention where the oil sorbent granules 44 of the sorbent 46 are each formed of or from extruded oil sorbent pellets 48 and 48′. As is shown in FIG. 1, each one of the oil sorbent pellets 48 and 48′ used in such a preferred oil sorbent embodiment preferably are used in their uncoated as extruded form without any treatment or coating applied after pellet extrusion. When an oil 70, such as a mineral oil having a viscosity no greater than 50 centipoises (Cp) at room temperature of between 68 degrees Fahrenheit and 77 degrees Fahrenheit (e.g., between 20-25 Celsius), is applied onto the pellets 48 and 48′ or the pellets 48 and 48′ are applied on a remediation area 72 containing such oil 70, the oil 70 begins to be immediately adsorbed or picked up by the pellets 48 and 48′.

When the pellets 48 and 48′ come into contact with the oil 70 or vice versa, oil 70 is drawn into each one of the pellets 48 and 48′ through one or more of the pores 52 and internal pockets 60 during adsorption. During adsorption, the void-filled internal starch matrix of each one of the pellets 48 and 48′ draws in oil via wicking and/or capillary action causing the pellets 48 and 48′ to fill up with and preferably become substantially completely saturated with oil 70.

During adsorption, oil 70 and/or one or more other liquid constituents in the oil 70 can and preferably do solubilize or at least partially dissolve at least some of the liquid soluble starch based material of each wetted pellet 48 and 48′ helping to facilitate adsorption. Where the oil 70 contains any aqueous components, e.g. water or any water-based liquid, water soluble starch-based material in each wetted pellet 48 and/or 48′ also at least partially dissolves or solubilizes. Doing so advantageously opens up additional channels and openings in each pellet 48 and 48′ that not only provide additional adsorption surface area and space that can hold oil 70 but which also provides additional routes or pathways through which the oil 70 can be drawn into the inner starch matrix of each wetted pellet 48 and/or 48′.

As is also depicted in FIG. 3, the outer boundaries or surfaces of each pellet 48 and 48′ adsorbing oil 70 begin to coalesce forming an agglutinative mass 74 containing at least a plurality of the pellets 48 and/or 48′ and which preferably contain at least a plurality of pairs of the pellets 48 and 48′. In a preferred method of granular oil sorbent use and operation, adsorption of oil 70 by the pellets 48 and 48′ not only wets the pellets 48 and 48′ but also causes each one of the pellets 48 and 48′ to at least lightly adhere to one another preferably via liquid soluble binder adhesion. Where wetting of outer pellet surfaces causes liquid soluble, preferably water soluble binder to become sticky or tacky and/or form flowable adhesive, oil adsorption can advantageously cause the pellets 48 and 48′ to become an agglutinated mass 74 that is more readily able to be picked up.

In a liquid soluble binder activation step depicted in FIG. 4, an aqueous liquid, such as water, can be and preferably is applied onto the pellets 48 and 48′ after each one of the pellets has absorbed at least some of the oil 70 in the vicinity of the remediation area 72. When the aqueous liquid is applied, the water in the aqueous liquid at least partially dissolves or solubilizes water soluble binder in and around the outer surfaces of each one of the pellets 48 and 48′ wetted by the aqueous liquid causing the outer surface of each wetted pellet 48 and 48′ to at least become sticky or tacky. As a result of application of the aqueous liquid, the boundary or outer surface of each one of the pellets 48 and 48′ wetted thereby breaks down and further coalesces into a single amorphous agglutinated mass 76 as also depicted in FIG. 4.

In the preferred embodiment shown in FIG. 4, wetting of the oil holding pellets 48 and 48′ with such an aqueous liquid, e.g., water, at least partially dissolves or solubilizes water soluble binder 75 in each wetted pellet 48 and 48′ causing the binder 75 to flow from, around and in between adjacent pellets 48 and 48′. When left to dry, the amorphous agglutinated mass 76 is formed of at least a plurality and preferably at least a plurality of pairs, i.e. at least three, of the oil holding aqueous solution wetted pellets 48 and 48′ adhered together by the binder 75 forming a clump 78 of amorphous, one-piece and substantially homogenous construction or composition that preferably further solidifies as water evaporates from the mass 76. When dried and/or cured, clump 78 preferably becomes substantially solid and hard having a clump compressive or clump crush strength of at least 60 pounds per square inch, preferably having a clump compressive or clump crush strength of at least 75 pounds per square inch, and preferably having a clump compressive or clump crush strength of at least 150 pounds per square inch. The formation of such a dried solid and/or hard clump 78 not only advantageously captures the oil adsorbed by each pellet 48 and 48′ within the dried and/or cured clump 78 but also releases virtually all water therefrom.

Although not shown in the drawings, in a subsequent recovery step, since each one of the pellets 48 and 48′ are organic and biodegradable, each agglutinated mass 74 and/or oil holding clump 76 can be processed after being removed, e.g. lifted, scooped up, or otherwise picked up from the remediation area 72 to recover at least some of the adsorbed oil held by the mass 74 or clump 76. In one preferred oil recovery step, the oil holding agglutinated mass 74 or oil holding clump 76 is centrifuged at a high enough centrifuge speed to cause the oil to separate therefrom and be collected. In another preferred oil recovery step, the oil holding agglutinated mass 74 or oil holding clump 76 can be pulverized and/or subjected to sufficient heat to volatilize at least some of the oil in the mass 74 or clump 76. In still another preferred oil recovery step, the oil holding agglutinated mass 74 or oil holding clump 76 can be incinerated in an energy recovery procedure, such as in a boiler of a steam powered electrical generating station or plant to produce electricity while advantageously disposing of oil held in such a mass 74 or clump 76 in an environmentally friendly manner.

In a preferred organic sorbent and method of use, where used as an oil stain remover of an oil stain in concrete where the stain has one of 256 shades on a grayscale shading scale, application of pellet 48 and/or 48′ and/or granules 44 formed thereof or therefrom of granular sorbent of the present invention onto the stain removes enough oil residing in pores, cracks and/or crevices in the concrete to lighten the shade of the stain at least one and preferably at least a plurality of shades compared to the darker shade of the stain prior to application. In one such preferred organic sorbent oil stain removing embodiment and method of stain removal using such a granular sorbent stain remover, application of pellet 48 and/or 48′ and/or granules 44 of granular absorbent of the present invention preferably lightens the shade of the stain at least a plurality of pairs, i.e. at least 3, of shades compared to the darker shade of the stain prior to application. In still another preferred embodiment, application of granular absorbent preferably lightens the shade of the stain at least 5 shades compared to the darker shade of the stain prior to application. In a further preferred embodiment, application of granular absorbent preferably lightens the shade of the stain at least 7 shades compared to the darker shade of the stain prior to application. In yet another preferred embodiment, application of granular absorbent preferably lightens the shade of the stain at least 10 shades compared to the darker shade of the stain prior to application. In still another preferred embodiment, application of granular absorbent preferably lightens the shade of the stain at least 15 shades compared to the darker shade of the stain prior to application. In yet still another preferred embodiment, application of granular absorbent preferably lightens the shade of the stain at least 25 shades compared to the darker shade of the stain prior to application. In yet a further preferred embodiment, application of granular absorbent preferably lightens the shade of the stain at least 30 shades compared to the darker shade of the stain prior to application.

Extruded pellets 48 and/or 48′ and/or granules 44 formed of or from such pellets 48 and/or 48′ of such organic sorbent of the present invention preferably are of dual or multi-sorbent construction as the organic sorbent pellets 48 and/or 48′ and/or granules 44 formed thereof or therefrom can be used in both oil absorbent applications and water absorbent applications. In one such preferred organic sorbent embodiment, such pellets 48 and/or 48′ and/or granules 44 formed thereof or therefrom each have at least one portion that is both oleophilic and hydrophobic and at least one other portion that is hydrophilic. Such extruded pellets 48 and/or 48′ and/or granules 44 formed thereof or therefrom of such organic sorbent of the present invention advantageously are thereby also of dual or multi-sorbent construction as the organic sorbent pellets 48 and/or 48′ and/or granules 44 formed thereof or therefrom can be used in both oil absorbent applications and water absorbent applications.

A preferred extruded granular sorbent and method of making extruded granular sorbent in accordance with the present invention produces pellets 48 and/or 48′ and/or granules 44 of organic sorbent of the present invention that preferably is organic oil sorbent usable not only for water sorbent applications, e.g. cat or animal litter, but which also is particularly well suited for water-insoluble liquid absorbent applications, e.g., oil adsorption. It is also contemplated that one or more embodiments of an extruded granular sorbent and/or at least one method of making extruded granular sorbent in accordance with the present invention produces extruded pellets 48 and/or 48′ and/or granules 44 formed thereof or therefrom of sorbent usable in chemical and hazardous waste treatment and/or remediation applications to pick up chemicals, hazardous waste, liquid containing chemicals and/or hazardous waste, petroleum-based liquids, volatile and nonvolatile oils, heavy hydrocarbons, light hydrocarbons, liquids insoluble in water, and the like.

In at least one preferred embodiment, air quenched and/or flash dried (without heating) of extruded granules/pellets substantially simultaneously as they are being discharged from the extruder die forms a highly amorphous structure cold water soluble amylopectin in each extruded pellet 48 and/or 48′ as discussed above. This cold water soluble amylopectin formed in each extruded pellet 48 and/or 48′ not only is instantized upon wetting with liquid, preferably water, in activating wetted pellet 48 and/or 48's as discussed elsewhere herein, it preferably causes dissolving and/or solubilizing of amylopectin and an amount sufficient for the dissolved/solubilized amylopectin to flow in the form of flowable adhesive from wetted pellets 48 and/or 48′. This not only facilitates rapid oil and/or liquid absorption and/or adsorption on and into such wetted pellet 48 and/or 48′, it provides or produces pellet 48 and/or 48′ of organic granular sorbent in accordance with the present invention that contains at least some oil soluble and/or water insoluble/immiscible liquid soluble material advantageously facilitating absorption and/or adsorption of oil and/or water insoluble/immiscible liquid during use in oil drying or oil absorbent applications.

Conventional oil absorbents are typically made of inorganic porous pebbles or rocks that are heavy to transport and difficult to dispose. The cost of disposing contaminated inorganic sorbent rocks is very high as the kilns end up adding the product to concrete at a low percentage. Where used or spent extruded granular sorbent of the present invention needs to be disposed of using high temperatures, such as by disposal in a kiln, at least some of and preferably substantially all of the organic material of the extruded granular sorbent actually becomes a combustion source in the kiln leaving only a very small amount of ash for disposal.

While extruded granular organic sorbents produced in accordance with the present invention are particularly well suited for use in oil dry or oil absorbent applications to pick up spilled oil and other types of liquid on land, at least one embodiment of extruded granular sorbent of the invention is well suited for use in oil spill cleanup applications to clean up oil spills on land and in water. Extruded pellets 48 and/or 48′ and/or granules 44 formed thereof or therefrom of sorbent of the present invention not only can be used to collect oil on land and in water, but also is easy to remove and dispose afterwards.

Oil can be cleaned up from water, e.g., oceans, lakes, ponds, marshes, rivers, streams, ditches, canals and the like, and land, e.g., beaches, soil, dirt, concrete, and the like, by enzymatic degradation using enzyme treatments. The problem with this type of remediation is that the enzymes designed to degrade hydrocarbons of the oil can end up functioning poorly and even effectively starve in a 100% oil environment, such as where the area sought to be treated is saturated with oil. Similar problems can occur where a bacterial treatment is used where bacteria is applied to breakdown the oil by eating or digesting the oil. In some instances, the byproducts of hydrocarbons digested by bacteria can form a barrier that prevents the bacteria from reaching oil underneath. This can cause the bacteria to take longer than desired to remediate the oil spill allowing the spill to undesirably spread and become even more difficult to remediate. Even worse, should bacteria populations in one or more areas of the spill die off as a result, remediation can be spotty or even incomplete. Should remediation take too long in any event, the spill can spread to an unmanageable area or even penetrate into the ground making complete remediation virtually impossible.

Organic sorbent of the present invention can be extruded with and/or treated after extrusion with one or more types of enzymes and/or one or more types of bacteria (and/or one or more types of fungi) used to degrade, e.g., biodegrade, oil and/or other types of hazardous liquids with the enzyme and/or bacteria containing extruded organic sorbent pellets 48 and/or 48′ and/or granules 44 formed thereof or therefrom enabling the enzymes and/or bacteria to be sustained longer and thrive better making them more effective for a longer time. Organic sorbent of the present invention can also be extruded with and/or treated after extrusion with one or more surfactants (including super-surfactants) together with the one or more types of enzymes and/or one or more types of bacteria (and/or one or more types of fungi). The starches, proteins and/or cellulose in each granule or pellet not only provide food for the bacteria and/or enzymes, but liquid soluble starch-based or starch-containing material in each pellet can solubilize and flow when wetted with liquid, e.g. water, helping to more evenly and more quickly spread the bacteria and/or enzymes and/or surfactants over a larger area of the spill or contaminated area.

Organic sorbent pellets 48 and/or 48′ and/or granules 44 formed thereof or therefrom containing or otherwise treated with one or more enzymes and/or surfactants and/or one or more bacteria produce organic sorbent pellets 48 and/or 48′ and/or granules 44 formed thereof or therefrom of the present invention that not only are remediation treatment enzyme, surfactant and/or bacteria carriers or vectors but also advantageously are enzyme, surfactant and/or bacteria dispensers that dispense enzymes, surfactants and/or bacteria into the surrounding area sought to be treated when the pellets 48 and/or 48′ and/or granules 44 formed thereof or therefrom are wetted. Depending upon the surface or makeup of the area to which such enzyme, surfactant and/or bacteria dispensing pellets 48 and/or 48′ and/or granules 44 formed thereof or therefrom are applied, liquid in the spill or hazardous material sought to be remediated can be the wetting liquid that activates each wetted granule or pellet causing dispensation or delivery of the enzymes, surfactants and/or bacteria from each pellet onto an adjacent portion of the spill or area sought to be remediated.

In one preferred remediation method using extruded organic sorbent pellets 48 and/or 48′ and/or granules 44 formed thereof or therefrom of such soluble composition, liquid from the spill or from the area sought to be remediated wets pellets 48 and/or 48′ and/or granules 44 formed thereof or therefrom spread on the spill or area activating the pellets 48 and/or 48′ and/or granules 44 formed thereof or therefrom causing liquid soluble material in each wetted granule or pellet to dissolve. Dissolving at least a portion of each wetted granule or pellet exposes an interior of the granule or pellet allowing one or more of the treatments, in this case, enzymes, surfactants, and/or bacteria, to be released there by distributing the treatments more evenly over the area where the pellets 48 and/or 48′ and/or granules 44 formed thereof or therefrom have been applied.

Where enzymes are involved, pellets or granules of the extruded organic sorbent support enzyme digestion as the enzymes can use the starch, protein, fat and/or fiber, e.g., cellulose, of the pellets 48 and/or 48′ and/or granules 44 formed thereof or therefrom as a food source while the enzymes are digesting the spill. In a preferred embodiment, enzymes in or applied to the pellets 48 and/or 48′ and/or granules 44 formed thereof or therefrom lie dormant and do not become active until the pellets 48 and/or 48′ and/or granules 44 formed thereof or therefrom are wetted such that no digestion by the enzymes can take place until the pellets 48 and/or 48′ and/or granules 44 formed thereof or therefrom are wetted.

In another preferred embodiment and method, enzymes can be applied onto pellets 48 and/or 48′ and/or granules 44 formed thereof or therefrom of granular sorbent that have been already applied to the area being remediated. In one such preferred embodiment and method, pellets 48 and/or 48′ and/or granules 44 formed thereof or therefrom are applied onto an oil spill before enzymes are applied to the pellets 48 and/or 48′ and/or granules 44 formed thereof or therefrom (and one the oil spill as well) enabling the enzymes to use the pellets 48 and/or 48′ and/or granules 44 formed thereof or therefrom as food while the enzymes are digesting the spill. In one such preferred embodiment and method, the enzymes can be contained in a liquid, e.g., water, which is sprayed on pellets 48 and/or 48′ and/or granules 44 formed thereof or therefrom already applied to a spill with the liquid activating or helping to active the enzymes. The liquid can also wet pellets 48 and/or 48′ and/or granules 44 formed thereof or therefrom causing liquid soluble starch containing material to be dissolved and flow therefrom that help provide a “boost” of food for the enzymes to accelerate digestion of the spill by the enzymes. In another preferred embodiment and method, the pellets 48 and/or 48′ and/or granules 44 formed thereof or therefrom are applied, then enzymes are applied, and lastly liquid, e.g., water, is applied on the pellets 48 and/or 48′ and/or granules 44 formed thereof or therefrom and the enzymes causing enzyme activation and/or providing a “shot” or “boost” of food that accelerates at least initially enzyme digestion of the spill. The same can be done with bacteria, which can feed on the pellets while digesting the oil in remediating the area of the oil spill. Surfactants can also be subsequently applied with at least some of the surfactant(s) absorbed by the pellets spreading out the time during remediation during which the applied surfactants remain effective in facilitating remediation by facilitating absorption, digestion, breakdown or dispersion of the oil of the oil spill.

Where the pellets 48 and/or 48′ and/or granules 44 formed thereof or therefrom are extruded from an admixture containing sufficient starch under extruder operating conditions that produce enough liquid soluble material in each granule or pellet that at least some liquid soluble material in each wetted pellet flows therefrom, each organic sorbent granule or pellet of the present invention functions as a treatment dispenser or delivery device that spreads the treatment beyond the immediate area or footprint occupied by the wetted granule or pellet. Extruded organic sorbent pellets 48 and/or 48′ and/or granules 44 formed thereof or therefrom of the present invention configured with one or more such treatments and extruded producing enough liquid soluble material in each extruded pellet to cause at least some of it to flow when wetted, produces treatment dispensing pellets 48 and/or 48′ and/or granules 44 formed thereof or therefrom that dispense one or more treatments in the flowable liquid soluble material that dissolves and flows from each pellet when wetted by liquid. The one or more treatments dispensed in the flowable liquid soluble material that dissolves and flows from each pellet wetted by liquid enables one or more treatments to soak into the ground or go into solution in liquid surrounding the wetted pellets helping to more evenly distribute and penetrate the oil and/or area sought to be remediated.

Where oil on the ground is sought to be remediated by treatment carrying extruded organic sorbent pellets 48 and/or 48′ and/or granules 44 formed thereof or therefrom of the present invention, distributing the treatment carrying pellets by spreading them on the ground over the contaminated area can activate one or more of the pellets 48 and/or 48′ and/or granules 44 formed thereof or therefrom where the ground is wet enough to wet one or more of the pellets 48 and/or 48′ and/or granules 44 formed thereof or therefrom. Where the ground is sufficiently wet, enough liquid from the ground can wet one or more of the pellets 48 and/or 48′ and/or granules 44 formed thereof or therefrom enough to cause at least some of the liquid soluble material of the wetted pellets 48 and/or 48′ and/or granules 44 formed thereof or therefrom to dissolve and flow therefrom carrying the one or more treatments of the granule or pellet with it as it flows onto and into the ground.

Where the ground is not sufficiently wet, a preferred method of remediation involves wetting the pellets 48 and/or 48′ and/or granules 44 formed thereof or therefrom by applying a liquid, preferably water, to activate the pellets 48 and/or 48′ and/or granules 44 formed thereof or therefrom. Where it is desired to activate the pellets 48 and/or 48′ and/or granules 44 formed thereof or therefrom into treatment dispensers, enough liquid is applied onto the pellets 48 and/or 48′ and/or granules 44 formed thereof or therefrom to not only cause at least a part of the outer surface of each wetted granule or pellet to dissolve, but enough liquid is applied to cause liquid soluble material of each wetted granule or pellet to also flow therefrom onto the ground carrying one or more treatments in the stream of flowable liquid soluble material. In a preferred embodiment, the liquid soluble flowable treatment carrier forms a treatment carrying liquid having a viscosity thicker than water that flows from each sufficiently wetted pellet onto the ground. One or more treatments, such as one or more enzymes and/or one or more bacteria, in each wetted granule or pellet are thereby dispensed therefrom in the stream or flow of liquid soluble material flowing from the granules and pellets.

In a preferred embodiment and method, where pellets 48 and/or 48′ and/or granules 44 formed thereof or therefrom have been wetted with enough liquid to produce flowable liquid soluble material that flows therefrom, at least some of the flowable liquid soluble material can flow around and in between adjacent pellets 48 and/or 48′ and/or granules 44 formed thereof or therefrom. In one such preferred embodiment and method, the liquid soluble material is a starch based liquid soluble material that preferably includes a liquid soluble binder or adhesive that can bind together or glued together adjacent pellets 48 and/or 48′ and/or granules 44 formed thereof or therefrom. This not only can clump the pellets 48 and/or 48′ and/or granules 44 formed thereof or therefrom together, producing clumps that are easier to remove when remediation is completed, but it also helps prevent the pellets 48 and/or 48′ and/or granules 44 formed thereof or therefrom from separating from one another during remediation. Where treatment carrying extruded organic absorbent pellets 48 and/or 48′ and/or granules 44 formed thereof or therefrom are spread on or otherwise applied to liquid, such as a spill in water, clumping of wetted pellets or granules advantageously keeps them together in the desired treatment location and also makes removal easier. As binder or adhesive in the liquid soluble material flows from and around adjacent pellets or granules clumping them together, the resultant clumps of pellets 48 and/or 48′ and/or granules 44 formed thereof or therefrom formed make removal and cleanup easier. Formation of clumps of pellets 48 and/or 48′ and/or granules 44 formed thereof or therefrom containing at least a plurality of pairs, i.e. at least 3, of pellets 48 and/or 48′ and/or granules 44 formed thereof or therefrom produce clumps larger than the size of the pellets or granules themselves which thereby are much easier to pick up out of the water when cleaning up after remediation has been completed (and/or when the clumped pellets or granules have soaked up or picked up enough to require their removal before applying more pellets or granules to continue remediation).

In one preferred embodiment and method, the liquid soluble material of each extruded granular sorbent is a water-soluble material that dissolves and exposes at least a portion of the interior of each granule or pellet wetted by water in activating each wetted granule or pellet. In such a preferred embodiment and method, where wetted with enough water, enough water-soluble material in each wetted granule or pellet dissolves or solubilizes to not only activate the wetted granule or pellet, at least some of the water-soluble material flows from each wetted granule or material. The water soluble material flowing from each greater wetted granule or material carries one or more treatments, e.g., one or more enzymes and/or one or more bacteria, in or with the flow of water soluble material onto the ground. Some of this remediation treatment carrying water soluble material can be absorbed into or otherwise penetrate the ground carrying with it the one or more remediation treatments thereby enabling remediation of oil and/or other hazardous contaminants that have soaked into or otherwise penetrated the ground.

It has been known that the enzymes designed to degrade the hydrocarbons effectively starve and are poorly efficient because they are fairly inactive in a 100% oil environment. Our extrudate (if impregnated with enzymes) with its oil absorbent attributes and its starch, protein and cellulose base allows the enzyme to remain well fed and active to digest the oil spill efficiently

In addition, in at least one preferred embodiment, pellets 48 and/or 48′ and/or granules 44 formed thereof or therefrom of extruded organic sorbent of the present invention can are treated with and/or otherwise include one or more treatments, chemicals, bacteria, fungi, enzymes, surfactants, coatings and/or the like that facilitate adsorption, absorption, pick up, retention, and/or disposal. In at least one preferred embodiment, pellets 48 and/or 48′ and/or granules 44 formed thereof or therefrom of extruded organic sorbent of the present invention are treated with and/or otherwise include one or more treatments, chemicals, bacteria, fungi, enzymes, surfactants, coatings and/or the like that breaks down, treats or otherwise remediates the ground, water or area surrounding the spill or contamination. In one such preferred embodiment, the pellets 48 and/or 48′ and/or granules 44 formed thereof or therefrom of extruded organic sorbent are treated with and/or otherwise include one or more treatments, chemicals, bacteria, fungi, enzymes, surfactants, coatings and/or the like that breaks down, treats or otherwise remediates the ground, water or area surrounding the spill or contamination even for a period of time after the spent or contaminated sorbent pellets or granules are removed. In one such preferred embodiment, such treated or treatment containing pellets 48 and/or 48′ and/or granules 44 formed thereof or therefrom release or otherwise distribute such one or more treatments, chemicals, bacteria, fungi, enzymes, surfactants, coatings and/or the like in the water and/or on the ground in the vicinity of where the pellets 48 and/or 48′ and/or granules 44 formed thereof or therefrom were applied thereby remediating at least some of the remaining amount of the oil, chemical and/or hazardous material. Similarly, such low density granular absorbent control can be and preferably also is employed to produce a low density granular absorbent used in oil spill remediation that advantageously allows for higher loading of the granular absorbent with heavier molecular weight surfactants and/or oil treatment materials without the granular absorbent product, namely organic oil sorbent pellets 48 and/or 48′ and/or oil absorbent granules 44 formed of or from such organic oil sorbent pellets 48 and/or 48′, losing buoyancy in water (whether coated or uncoated).

The present invention is directed to a granular sorbent comprised of a plurality of sorbent granules, each formed of or from a starch-containing oil sorbent pellet extruded from a starch-containing admixture. Each extruded oil sorbent pellet of the granular sorbent is porous, has a void-filled interior with a plurality of internally-disposed pockets, and is organic and biodegradable. Each extruded oil sorbent pellet of the granular sorbent also has an oil adsorption capacity of at least 0.85 grams of oil per gram of extruded sorbent pellet. In addition, each extruded oil sorbent pellet of the granular sorbent is composed of liquid soluble material that at least partially dissolves or solubilizes when wetted with oil increasing oil adsorption. Each extruded oil sorbent pellet of the granular sorbent is composed of water soluble material, as well as being composed of water soluble binder.

The granular sorbent wherein each extruded oil sorbent pellet is composed of at least 5% water soluble binder by pellet weight, composed of at least 7% water soluble binder by pellet weight, or is composed of at least 10% water soluble binder by pellet weight. Each extruded oil sorbent pellet is composed of liquid soluble binder and agglutinates with at least a plurality of other sorbent granules when wetted by oil adsorbed thereby, which forms an agglutinated mass of oil-holding granules. Each extruded oil sorbent pellet is composed of water soluble binder, and wherein the agglutinated mass of oil-holding granules form a clump therefrom when wetted with an aqueous liquid. The clump hardens into a solid clump when water from the aqueous liquid used to wet the agglutinated mass evaporates or dries from the clump; this solid clump has a clump compressive or clump crush strength of at least sixty pounds per square inch. At least one of the sorbent granules is formed of or from an extruded oil sorbent pellet having at least one elongate lobe projecting outwardly from a body of the extruded oil sorbent pellet that is larger than the at least one elongate lobe also has an oil adsorption capacity of at least 0.85 grams of oil per gram of extruded sorbent pellet, and comprises a splayed pellet having at least a portion of a starch matrix pellet interior exteriorly exposed. At least one of the sorbent granules formed of or from the extruded oil sorbent pellet having the at least one elongate lobe has a porous outer pellet surface comprised of a plurality of pores formed therein and comprises a splayed pellet having at least a portion of a void-filled pellet interior exteriorly exposed. Having the at least one elongate lobe, the extruded oil sorbent pellet has a porous outer pellet surface comprised of a plurality of pores formed therein. At least one of the sorbent granules is formed of or from an extruded oil sorbent pellet having (a) at least one elongate lobe extending outwardly from a body of the extruded oil sorbent pellet that is larger than the at least one elongate lobe, and (b) at least one elongate tendril extending outwardly from one of the pellet body and at least one lobe that is smaller than the at least one lobe. The at least one of the sorbent granules formed of or from the extruded oil sorbent pellet also has an oil adsorption capacity of at least 0.85 grams of oil per gram of extruded sorbent pellet. The granular sorbent wherein the at least one of the sorbent granules formed of or from the extruded oil sorbent pellet has a porous outer pellet surface comprised of a plurality of pores formed therein. The granular sorbent wherein the at least one of the sorbent granules formed of or from the extruded oil sorbent pellet comprises a splayed pellet having at least a portion of a void-filled pellet interior exteriorly exposed. The granular sorbent wherein the at least one of the sorbent granules formed of or from the extruded oil sorbent pellet comprises a splayed pellet having at least a portion of a starch matrix pellet interior exteriorly exposed. A granular sorbent comprised of a plurality of starch-containing oil sorbent pellets each extruded from a starch-containing admixture. The granular sorbent of claim wherein each one of the extruded oil sorbent pellets is porous, has a void-filled interior with a plurality of internally-disposed pockets, and is composed of water soluble binder. The granular sorbent wherein each one of the extruded oil sorbent pellets is porous, has a void-filled interior with a plurality of internally-disposed pockets, and is composed of water soluble binder in an amount sufficient to form an agglutinated mass of the pellets when wetted with an aqueous liquid. The granular sorbent wherein each one of the extruded oil sorbent pellets is porous, has a void-filled interior with a plurality of internally-disposed pockets, and is composed of water soluble binder in an amount sufficient to form an agglutinated mass of the extruded oil sorbent pellets when wetted with an aqueous liquid after the extruded oil sorbent pellets have adsorbed oil. The granular sorbent wherein each one of the extruded oil sorbent pellets is porous, has a void-filled interior with a plurality of internally-disposed pockets, and is composed of water soluble binder in an amount sufficient to form a clump of the extruded oil sorbent pellets when wetted with an aqueous liquid. The granular sorbent wherein each one of the extruded oil sorbent pellets is porous, has a void-filled interior with a plurality of internally-disposed pockets, and is composed of water soluble binder in an amount sufficient to form a clump of the extruded oil sorbent pellets when wetted with an aqueous liquid after the extruded oil sorbent pellets have adsorbed oil. The granular sorbent wherein each one of the extruded oil sorbent pellets is porous, has a void-filled interior with a plurality of internally-disposed pockets, and is composed of water soluble binder in an amount sufficient to form a clump of the extruded oil sorbent pellets when wetted with an aqueous liquid after the extruded oil sorbent pellets have adsorbed oil, and wherein the clump hardens into a solid clump when water from the aqueous liquid used to wet the extruded oil sorbent pellets evaporates or dries from the clump producing a solid clump having a clump compressive or clump crush strength of at least sixty pounds per square inch. The granular sorbent wherein each one of the extruded oil sorbent granules has at least one elongate lobe projecting outwardly from a body of the extruded oil sorbent pellet that is larger than the at least one elongate lobe. The granular sorbent wherein each one of the extruded oil sorbent pellets has (a) at least one elongate lobe extending outwardly from a body of the extruded oil sorbent pellet that is larger than the at least one elongate lobe, and (b) at least one elongate tendril extending outwardly from one of the pellet body and at least one lobe that is smaller than the at least one lobe. The granular sorbent wherein each extruded oil sorbent pellet has an oil adsorption capacity of at least 0.85 grams of oil per gram of extruded oil sorbent pellet.

Understandably, the present invention has been described above in terms of one or more preferred embodiments and methods. It is recognized that various alternatives and modifications may be made to these embodiments and methods that are within the scope of the present invention. Various alternatives are contemplated as being within the scope of the present invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

What is claimed is:

1. A granular sorbent comprised of a plurality of sorbent granules each formed of or from a starch-containing oil sorbent pellet extruded from a starch-containing admixture.

2. The granular sorbent of claim 1 wherein each extruded oil sorbent pellet is porous, has a void-filled interior with a plurality of internally-disposed pockets, and is organic and biodegradable.

3. The granular sorbent of claim 2 wherein each extruded oil sorbent pellet has an oil adsorption capacity of at least 0.85 grams of oil per gram of extruded sorbent pellet.

4. The granular sorbent of claim 2 wherein each extruded oil sorbent pellet is composed of liquid soluble material that at least partially dissolves or solubilizes when wetted with oil increasing oil adsorption.

5. The granular sorbent of claim 4 wherein each extruded oil sorbent pellet has an oil adsorption capacity of at least 0.85 grams of oil per gram of extruded sorbent pellet.

6. The granular sorbent of claim 2 wherein each extruded oil sorbent pellet is composed of water soluble material.

7. The granular sorbent of claim 6 wherein each extruded oil sorbent pellet has an oil adsorption capacity of at least 0.85 grams of oil per gram of extruded sorbent pellet.

8. The granular sorbent of claim 2 wherein each extruded oil sorbent pellet is composed of water soluble binder.

9. The granular sorbent of claim 8 wherein each extruded oil sorbent pellet has an oil adsorption capacity of at least 0.85 grams of oil per gram of extruded oil sorbent pellet.

10. The granular sorbent of claim 2 wherein each extruded oil sorbent pellet is composed of at least 5% water soluble binder by pellet weight.

11. The granular sorbent of claim 2 wherein each extruded oil sorbent pellet is composed of at least 7% water soluble binder by pellet weight.

12. The granular sorbent of claim 2 wherein each extruded oil sorbent pellet is composed of at least 10% water soluble binder by pellet weight.

13. The granular sorbent of claim 1 wherein each extruded oil sorbent pellet is composed of liquid soluble binder and agglutinates with at least a plurality of other sorbent granules when wetted by oil adsorbed thereby.

14. The granular sorbent of claim 13 wherein the sorbent granules form an agglutinated mass of oil-holding granules.

15. The granular sorbent of claim 14 wherein each extruded oil sorbent pellet is composed of water soluble binder, and wherein the agglutinated mass of oil-holding granules form a clump therefrom when wetted with an aqueous liquid.

16. The granular sorbent of claim 15 wherein the clump hardens into a solid clump when water from the aqueous liquid used to wet the agglutinated mass evaporates or dries from the clump.

17. The granular sorbent of claim 16 wherein the solid clump has a clump compressive or clump crush strength of at least sixty pounds per square inch.

18. The granular sorbent of claim 1 wherein at least one of the sorbent granules is formed of or from an extruded oil sorbent pellet having at least one elongate lobe projecting outwardly from a body of the extruded oil sorbent pellet that is larger than the at least one elongate lobe.

19. The granular sorbent of claim 18 wherein the at least one of the sorbent granules formed of or from the extruded oil sorbent pellet having the at least one elongate lobe has an oil adsorption capacity of at least 0.85 grams of oil per gram of extruded sorbent pellet.

20. The granular sorbent of claim 18 wherein the at least one of the sorbent granules formed of or from the extruded oil sorbent pellet having the at least one elongate lobe comprises a splayed pellet having at least a portion of a starch matrix pellet interior exteriorly exposed.

21. The granular sorbent of claim 19 wherein the at least one of the sorbent granules formed of or from the extruded oil sorbent pellet having the at least one elongate lobe has a porous outer pellet surface comprised of a plurality of pores formed therein.

22. The granular sorbent of claim 21 wherein the at least one of the sorbent granules formed of or from the extruded oil sorbent pellet having the at least one elongate lobe comprises a splayed pellet having at least a portion of a void-filled pellet interior exteriorly exposed.

23. The granular sorbent of claim 22 wherein the at least one of the sorbent granules formed of or from the extruded oil sorbent pellet having the at least one elongate lobe has a porous outer pellet surface comprised of a plurality of pores formed therein.

24. The granular sorbent of claim 1 wherein at least one of the sorbent granules is formed of or from an extruded oil sorbent pellet having (a) at least one elongate lobe extending outwardly from a body of the extruded oil sorbent pellet that is larger than the at least one elongate lobe, and (b) at least one elongate tendril extending outwardly from one of the pellet body and at least one lobe that is smaller than the at least one lobe.

25. The granular sorbent of claim 24 wherein the at least one of the sorbent granules formed of or from the extruded oil sorbent pellet has an oil adsorption capacity of at least 0.85 grams of oil per gram of extruded sorbent pellet.

26. The granular sorbent of claim 25 wherein the at least one of the sorbent granules formed of or from the extruded oil sorbent pellet has a porous outer pellet surface comprised of a plurality of pores formed therein.

27. The granular sorbent of claim 25 wherein the at least one of the sorbent granules formed of or from the extruded oil sorbent pellet comprises a splayed pellet having at least a portion of a void-filled pellet interior exteriorly exposed.

28. The granular sorbent of claim 25 wherein the at least one of the sorbent granules formed of or from the extruded oil sorbent pellet comprises a splayed pellet having at least a portion of a starch matrix pellet interior exteriorly exposed.

29. A granular sorbent comprised of a plurality of starch-containing oil sorbent pellets each extruded from a starch-containing admixture.

30. The granular sorbent of claim 29 wherein each one of the extruded oil sorbent pellets is porous, has a void-filled interior with a plurality of internally-disposed pockets, and is composed of water soluble binder.

31. The granular sorbent of claim 29 wherein each one of the extruded oil sorbent pellets is porous, has a void-filled interior with a plurality of internally-disposed pockets, and is composed of water soluble binder in an amount sufficient to form an agglutinated mass of the pellets when wetted with an aqueous liquid.

32. The granular sorbent of claim 29 wherein each one of the extruded oil sorbent pellets is porous, has a void-filled interior with a plurality of internally-disposed pockets, and is composed of water soluble binder in an amount sufficient to form an agglutinated mass of the extruded oil sorbent pellets when wetted with an aqueous liquid after the extruded oil sorbent pellets have adsorbed oil.

33. The granular sorbent of claim 29 wherein each one of the extruded oil sorbent pellets is porous, has a void-filled interior with a plurality of internally-disposed pockets, and is composed of water soluble binder in an amount sufficient to form a clump of the extruded oil sorbent pellets when wetted with an aqueous liquid.

34. The granular sorbent of claim 29 wherein each one of the extruded oil sorbent pellets is porous, has a void-filled interior with a plurality of internally-disposed pockets, and is composed of water soluble binder in an amount sufficient to form a clump of the extruded oil sorbent pellets when wetted with an aqueous liquid after the extruded oil sorbent pellets have adsorbed oil.

35. The granular sorbent of claim 29 wherein each one of the extruded oil sorbent pellets is porous, has a void-filled interior with a plurality of internally-disposed pockets, and is composed of water soluble binder in an amount sufficient to form a clump of the extruded oil sorbent pellets when wetted with an aqueous liquid after the extruded oil sorbent pellets have adsorbed oil, and wherein the clump hardens into a solid clump when water from the aqueous liquid used to wet the extruded oil sorbent pellets evaporates or dries from the clump producing a solid clump having a clump compressive or clump crush strength of at least sixty pounds per square inch.

36. The granular sorbent of claim 29 wherein each one of the extruded oil sorbent granules has at least one elongate lobe projecting outwardly from a body of the extruded oil sorbent pellet that is larger than the at least one elongate lobe.

37. The granular sorbent of claim 29 wherein each one of the extruded oil sorbent pellets has (a) at least one elongate lobe extending outwardly from a body of the extruded oil sorbent pellet that is larger than the at least one elongate lobe, and (b) at least one elongate tendril extending outwardly from one of the pellet body and at least one lobe that is smaller than the at least one lobe

38. The granular sorbent of any one of claims 29 through 37 wherein each extruded oil sorbent pellet has an oil adsorption capacity of at least 0.85 grams of oil per gram of extruded oil sorbent pellet.
